(19) United States
(12) Patent Application Publication
(10) Pub. No.: US 2001/0048541 A1
(43) Pub. Date: Dec. 6, 2001

(54) Delay equalizer, optical transmitter using same delay equalizer, and optical transmission system

(75) Inventor: Yoshikazu Ishii, Yokohama-shi (JP)

Correspondence Address: Connolly Bove Lodge & Hutz LLP, Suite 800, 1990 M Street, N.W., Washington, DC, 20036-3425, US

(73) Assignee: Matsushita Electric Industrial Co., Ltd., Osaka (JP)

(21) Appl. No.: 09/854,558

(22) Filed: May 15, 2001

(30) Foreign Application Priority Data
May 25, 2000 (JP) 2000-155205

(51) Int. Cl. H04B 10/04

(52) U.S. Cl. 359/181; 359/182

(57) ABSTRACT

In an optical transmission system comprising an optical transmitter, including a frequency modulator for frequency-modulating frequency-multiplexed multi-channel signals and an optical modulator for intensity-modulating signal light with batched modulated signals obtained by the frequency modulator, and an optical receiver for optical/electrical-converting and frequency-demodulating the batched frequency-modulated signal, a delay equalizer is provided before the optical modulator in the optical transmitter. The delay equalizer is composed of an inductor and a capacitor, which constitute a resonance circuit with a resonance frequency determining a center frequency for delay equalization, and a variable resistor made variable in resistance. A Q value of the resonance circuit is controlled in accordance with a variation of the resistance of the variable resistor so that a quantity of delay equalization is made variable. With this circuit arrangement, the delay equalizer can equalize the delay deviation on a signal transmission line in the optical transmitter and further the delay deviation on a signal transmission line in the optical receiver, reducing the delay distortion stemming from the delay deviation of the entire system from the optical transmitter to the optical receiver.

### BACKGROUND OF THE INVENTION

1) Field of the Invention

The present invention relates to a delay equalizer for equalizing a delay characteristic of a transmission line, an optical transmitter for performing frequency modulation (FM) of frequency-multiplexed (frequency-division-multiplexed) multi-channel signals in optical transmission in batches, which exert influence on the signal transmission quality after transmission depending upon a delay characteristic of a transmission line, and an optical transmission system using this optical transmitter.

2) Description of the Related Art

So far, as a delay equalizer, there has been known an equalizer disclosed in Japanese Unexamined Patent Publication No. 03 (HEI)-3411. FIG. 18 is an illustration of a circuit arrangement of a conventional delay equalizer. The circuit arrangement of this delay equalizer is such that a series circuit comprising an inductor L5 and a resistor R8 and a series circuit comprising capacitors C5 and C6 are connected in parallel with each other between input and output terminals and a connection between the capacitors C5 and C6 is grounded through a series circuit comprising an inductor L6, a capacitor C7 and a resistor R9. In this arrangement, the curvature component of amplitude/frequency characteristics steps up as the resistance of the resistors R8 and R9 increase, which causes an enhancement in delay compensation.

In addition, a conventional optical transmitter made to frequency-modulate frequency-multiplexed multi-channel signals simultaneously and an optical transmission system using this optical transmitter have been known by Japanese Unexamined Patent Publication No. 8 (HEI)-274714. FIG. 19 is a block diagram showing a configuration of the conventional optical transmission system, where an optical transmitter 4 is shown as comprising a frequency modulator 1 and an optical modulator 3 and an optical receiver 8 is shown as comprising an optical receive unit 6 and a frequency demodulator 7. In this configuration, frequency-multiplexed multi-channel signals are simultaneously frequency-modulated in the frequency modulator 1 and optically intensity-modulated in the optical modulator 3, before transmitted through an optical fiber transmission line 5. On the other hand, in the optical receiver 8, the collectively frequency-modulated signal is photoelectrically converted (optical-electrical-converted) in the optical receive unit 6 and frequency-demodulated in the frequency demodulator 7, thereby regenerating frequency-multiplexed multi-channel signals.

In the case of the conventional delay equalizer, however, difficulty is encountered in flexibly varying a delay equalization quantity according to transmission line undergoing delay equalization, which creates a problem in coping flexibly with variations of delay characteristics after system installation, and although equalization is achievable with respect to delay in the vicinity of the resonance frequency depending on the conductance of a conductor and the capacitance of a capacitor, difficulty is experienced in accomplishing delay equalization throughout a wide band of frequencies so that it is inapplicable to a system requiring the delay equalization over a wide band of frequencies.

### SUMMARY OF THE INVENTION

The present invention has been developed with a view to eliminating the above-mentioned problems, and it is therefore an object of the invention to provide a delay equalizer capable of coping flexibly with variations of delay characteristics of transmission lines, of equalizing the delay characteristics over a wideband of frequencies and of offering delay equalization characteristics to delay characteristics of transmission lines, and an optical transmitter and optical transmission system using this delay equalizer.

For this purpose, in accordance with an aspect of the present invention, there is provided a delay equalizer connected between input and output terminals and comprising an inductor and a capacitor, which constitute a resonance circuit with a given resonance frequency determining a center frequency for delay equalization, and a variable resistor made variable in resistance, with the Q value of the resonance circuit being varied by a change of the resistance of the variable resistor to vary a quantity of the delay equalization. With this circuit arrangement, the resistance value of the variable resistor can be changed to vary the quantity or degree of delay equalization.

Furthermore, in accordance with another aspect of the present invention, there is provided a delay equalizer connected between input and output terminals and comprising an inductor and a variable capacitance capacitor made variable in capacitance, which constitute a resonance circuit with a given resonance frequency determining a center frequency for delay equalization, and a variable resistor made variable in resistance, with the center frequency for the delay equalization being made variable with a variation of the capacitance of the variable capacitance capacitor, and a Q value of the resonance circuit being varied with a variation of resistance of the variable resistor to vary the degree of delay equalization. With this circuit arrangement, the capacitance of the variable capacitance capacitor can be varied to change the center frequency for varying delay characteristic while the resistance of the variable resistor can be varied to change the degree of delay equalization.

In the foregoing delay equalizer, a PIN diode is used as the variable resistor and a power circuit is provided to control a current flowing through the PIN diode, with the current flowing through the PIN diode being controlled to change an internal resistance of the PIN diode so that the degree of delay equalization is made variable. That is, with this circuit arrangement, the internal resistance is varied by controlling the current flowing through the PIN diode, thereby varying the degree of delay equalization.

In addition, in the foregoing delay equalizer, a voltage variable capacitor whose capacitance is made variable through voltage control is used as the variable capacitor and a power circuit is provided to control a voltage across the voltage variable-capacitance capacitor, with the voltage across the voltage variable capacitor being controlled to vary the resonance frequency of the resonance circuit comprising the inductor and the capacitor so that the center frequency for the delay equalization is made variable. That is, with this circuit arrangement, the resonance frequency of the resonance circuit is varied by controlling the voltage value across the voltage variable capacitor, thereby changing the delay characteristic with a variation of the center frequency.

Still additionally, in the foregoing delay equalizer, an PIN diode is used as the variable resistor, a first power circuit is provided to control a current flowing through the PIN diode, a voltage variable capacitor whose capacitance is made variable under voltage control is used as the variable capacitor, and a second power circuit is provided to control a voltage across the voltage variable capacitor, with the current flowing the PIN diode being controlled by the first power circuit to vary an internal resistance of the PIN diode so that the degree of delay equalization is made variable, and the voltage across the voltage variable capacitor being controlled by the second power circuit to vary the resonance frequency of the resonance circuit so that the center frequency for the delay equalization is made variable. With this circuit arrangement, the internal resistance can be changed by controlling the current flowing through the PIN diode, thereby varying the degree of delay equalization, and the voltage value across the voltage variable capacitor can be controlled to vary the resonance frequency of the resonance circuit comprising the inductor and the capacitor, thus varying the center frequency causing a variation of the delay characteristic.

Moreover, in the foregoing delay equalizer, a plurality of delay equalizing sections each comprising an inductor, a capacitor and a variable resistor are cascade-connected between input and output terminals, with resistance of the variable resistors of the delay equalizing sections being individually controlled to vary the degree of delay equalization according to center frequency of each delay equalizing section. With this circuit arrangement, the resistance of the variable resistor of each of the delay equalizing sections is controlled independently to vary the degree of delay equalization, which enables the delay equalization characteristic to be freely changed over a wideband of frequencies.

Still moreover, in the foregoing delay equalizer, a plurality of delay equalizing sections each comprising an inductor, a variable capacitor and a variable resistor are cascade-connected between input and output terminals, with the capacitance of the variable capacitors of the delay equalizing sections being individually controlled to vary the resonance frequency of the resonance circuit so that the center frequency for the delay equalization is made variable, and the resistance of the variable resistors of the delay equalizing sections being individually controlled to vary the degree of delay equalization according to center frequency of each delay equalizing section. With this circuit arrangement, the resonance frequency of the resonance circuit can be varied by controlling the capacitance of the variable capacitor of each of the delay equalizing sections, thus varying the center frequency causing a variation of the delay characteristic. In addition, the degree of equalization can be varied by controlling the resistance of the variable resistor of each of the delay equalizing sections, which enables the delay equalization characteristic to be freely changed over a wideband of frequencies.

In addition, in the foregoing delay equalizer, each of the delay equalizing sections includes a PIN diode serving as the variable resistor and a power circuit for controlling a current flowing through the PIN diode so that the current flowing through the PIN diode of each of the delay equalizing sections is controlled to freely vary the degree of delay equalization. With this circuit arrangement, the internal resistance of the PIN diode is changed by independently controlling the value of a current flowing through the PIN diode of each of the delay equalizing sections, which enables the degree of delay equalization to be varied over a wideband of frequencies.

Still additionally, in the foregoing delay equalizer, each of the delay equalizing sections includes a voltage variable capacitor whose capacitance is made variable in accordance through voltage control and which serves as the variable capacitor and a power circuit for controlling a voltage across the voltage variable capacitor, with the voltage across the voltage variable capacitor of each of the delay equalizing sections is controlled to vary the resonance frequency of the resonance circuit for freely varying the center frequency at every delay equalizing section. With this circuit arrangement, the resonance frequency of the resonance circuit is varied by independently controlling a value of a voltage across the voltage variable capacitor of each of the delay equalizing sections, which varies the center frequency for varying the delay characteristic of each of the delay equalizing sections.

Still additionally, in the foregoing delay equalizer, each of the delay equalizing sections includes a PIN diode serving as the variable resistor, a first power circuit for controlling a current passing through the PIN diode, a voltage variable capacitor whose capacitance is made variable through voltage control and which services as the variable capacitor, and a second power circuit for controlling a voltage across the voltage variable capacitor, with the current flowing through the PIN diode of each of the delay equalizing sections being controlled by the first power circuit to vary the internal resistance of the PIN diode so that the degree of delay equalization is made variable at every delay equalizing section, and the voltage across the voltage variable capacitor being controlled by the second power circuit to vary the resonance frequency of the resonance circuit comprising the inductor and the capacitor so that the center frequency is made variable at every delay equalizing section. With this circuit arrangement, the resonance frequency of the resonance circuit is varied by independently controlling the value of the voltage across the voltage variable capacitor of each of the delay equalizing sections, which independently varies the center frequency to cause a variation of the delay characteristic of each of the delay equalizing sections.

Furthermore, in accordance with a further aspect of the present invention, there is provided an optical transmitter comprising frequency modulating means for frequency-modulating frequency-multiplexed multi-channel signals, optical modulating means for intensity-modulating signal light with batched modulated signals obtained by the frequency modulating means for optical transmission, and a delay equalizer provided before the optical modulating means and including an inductor and a capacitor, which constitute a resonance circuit with a given resonance frequency determining a center frequency for delay equalization, and a variable resistor made variable in resistance, with the Q value of the resonance circuit being varied by varying the resistance of the variable resistor so that the degree of delay equalization is made variable. With this circuit arrangement, the resistance of the variable resistor of the delay equalizer is varied to equalize the delay deviation on a batched frequency-modulated signal transmission line in the optical transmitter, thereby reducing the delay distortion occurring due to the delay deviation.

Still furthermore, in accordance with a further aspect of the present invention, there is provided an optical transmitter comprising frequency modulating means for frequency-modulating frequency-multiplexed multi-channel signals, optical modulating means for intensity-modulating signal light with batched modulated signals obtained by the frequency modulating means for optical transmission, and a delay equalizer provided before the optical modulating means and including an inductor and a variable capacitor made variable in capacitance, which constitute a resonance circuit with a given resonance frequency which determines a center frequency for delay equalization, and a variable resistor made variable in resistance, with the center frequency for the delay equalization being made variable by varying the capacitance of the variable capacitor and the Q value of the resonance circuit being made variable by varying the resistance of the variable resistor so that the degree of delay equalization is made variable. With this circuit arrangement, the value of capacitance of the variable capacitor of the delay equalizer is varied to equalize the delay deviation on a batched frequency-modulated signal transmission line in the optical transmitter, thereby reducing the delay distortion occurring due to the delay deviation.

Still furthermore, in accordance with a further aspect of the present invention, there is provided an optical transmitter comprising frequency modulating means for frequency-modulating frequency-multiplexed multi-channel signals, optical modulating means for intensity-modulating signal light with batched modulated signals obtained by the frequency modulating means for optical transmission, and a delay equalizer provided before the optical modulating means and including an inductor and a capacitor, which constitute a resonance circuit with a given resonance frequency determining a center frequency for delay equalization, and a PIN diode made variable in resistance, and a power circuit for controlling a current flowing through the PIN diode, with the current flowing through the PIN diode being controlled to vary an internal resistance of the PIN diode so that the degree of delay equalization is made variable. With this circuit arrangement, the current value in the PIN diode of the delay equalizer is controlled to equalize the delay deviation on a batched frequency-modulated signal transmission line in the optical transmitter, thereby reducing the delay distortion occurring due to the delay deviation.

Moreover, in accordance with a further aspect of the present invention, there is provided an optical transmitter comprising frequency modulating means for frequency-modulating frequency-multiplexed multi-channel signals, optical modulating means for intensity-modulating signal light with batched modulated signals obtained by the frequency modulating means for optical transmission, and a delay equalizer provided before the optical modulating means and including an inductor and a voltage variable capacitor made variable in capacitance through voltage control, which constitute a resonance circuit with a given resonance frequency determining a center frequency for delay equalization, a variable resistor made variable in resistance, and a power circuit for controlling a voltage across the voltage variable capacitor, with the Q value of the resonance circuit being made variable by varying the resistance of the variable resistor so that the degree of delay equalization is made variable, and the value of the voltage across the voltage variable capacitor being controlled to vary the resonance frequency of the resonance circuit so that the center frequency for the delay equalization is made variable. With this circuit arrangement, the value of capacitance of the voltage variable capacitor of the delay equalizer is varied to equalize the delay deviation on a batched frequency-modulated signal transmission line in the optical transmitter, thereby reducing the delay distortion occurring due to the delay deviation.

Still moreover, in accordance with a further aspect of the present invention, there is provided an optical transmitter comprising frequency modulating means for frequency-modulating frequency-multiplexed multi-channel signals, optical modulating means for intensity-modulating signal light with batched modulated signals obtained by the frequency modulating means for optical transmission, and a delay equalizer provided before the optical modulating means and including an inductor, a voltage variable capacitor made variable in capacitance through voltage control, which constitute a resonance circuit with a given resonance frequency determining a center frequency for delay equalization, a PIN diode made variable in resistance, a first power circuit for controlling a current flowing through the PIN diode, and a second power circuit for controlling a voltage across the voltage variable capacitor, with the current flowing through the PIN diode being controlled by the first power circuit to vary an internal resistance of the PIN diode so that the degree of delay equalization is made variable, and the voltage across the voltage variable capacitor being controlled by the second power circuit to vary the resonance frequency of the resonance circuit so that a central frequency for delay equalization is made variable. With this circuit arrangement, the resistance value of the PIN diode and the capacitance value of the voltage variable capacitor in the delay equalizer are controlled to equalize the delay deviation on a batched frequency-modulated signal transmission line in the optical transmitter, thereby reducing the delay distortion occurring due to the delay deviation.

In addition, in accordance with a further aspect of the present invention, there is provided an optical transmitter comprising frequency modulating means for frequency-modulating frequency-multiplexed multi-channel signals, optical modulating means for intensity-modulating signal light with batched modulated signals obtained by the frequency modulating means for optical transmission, and a delay equalizer provided before the optical modulating means and including a plurality of delay equalizing sections, each comprising an inductor, a capacitor and a variable resistor, cascade-connected between input and output terminals, with the degree of delay equalization being made variable according to center frequency of each delay equalizing section by individually controlling the resistance of the variable resistor of each of the delay equalizing sections. With this circuit arrangement, the delay equalizing sections cascade-connected equalize the delay deviation on a batched frequency-modulated signal transmission line in the optical transmitter over a high band, thereby reducing the delay distortion occurring due to the delay deviation.

Still additionally, in accordance with a further aspect of the present invention, there is provided an optical transmitter comprising frequency modulating means for frequency-modulating frequency-multiplexed multi-channel signals, optical modulating means for intensity-modulating signal light with batched modulated signals obtained by the frequency modulating means for optical transmission, and a delay equalizer provided before the optical modulating means and including a plurality of delay equalizing sections, each comprising an inductor, a variable capacitor and a variable resistor, cascade-connected between input and output terminals, with a resonance frequency of a resonance circuit being varied by individually controlling a capacitance of the variable capacitor of each of the delay equalizing sections so that a center frequency for delay equalization being made variable, and the degree of delay equalization being made variable according to center frequency by individually controlling the resistance of the variable resistor of each of the delay equalizing sections. With this circuit arrangement, the delay equalizing sections cascade-connected equalize the delay deviation on a batched frequency-modulated signal transmission line in the optical transmitter over a wideband, thereby reducing the delay distortion occurring due to the delay deviation.

In the optical transmitter, each of the delay equalizing sections includes a PIN diode serving as the variable resistor and a power circuit for controlling a current flowing through the PIN diode, with the current flowing through the PIN diode of each of the delay equalizing sections being controlled to vary an internal resistance of the PIN diode so that the degree of delay equalization is made variable. With this circuit arrangement, the delay equalizing sections cascade-connected equalize the delay deviation on a batched frequency-modulated signal transmission line in the optical transmitter over a wideband, thereby reducing the delay distortion occurring due to the delay deviation.

In addition, in the optical transmitter, each of the delay equalizing sections includes a voltage variable capacitor made variable in capacitance through voltage control and serving as the variable capacitor and a power circuit for controlling a voltage across the voltage variable capacitor, with the voltage value across the voltage variable capacitor of each of the delay equalizing sections being controlled to vary a resonance frequency of a resonance circuit so that a center frequency is made variable at every delay equalizing section. With this circuit arrangement, the delay equalizing sections cascade-connected equalize the delay deviation on a batched frequency-modulated signal transmission line in the optical transmitter over a wideband, thereby reducing the delay distortion occurring due to the delay deviation.

Still additionally, in the optical transmitter, each of the delay equalizing sections includes a PIN diode serving as the variable resistor, a first power circuit for controlling a current flowing through the PIN diode, a voltage variable capacitor made variable in capacitance through voltage control and serving as the variable capacitor, and a second power circuit for controlling a voltage across the voltage variable capacitor, with the current flowing through the PIN diode of each of the delay equalizing sections being controlled by the first power circuit to vary an internal resistance of the PIN diode so that the degree of delay equalization is made variable at every delay equalizing section, and the voltage across the voltage variable capacitor being controlled by the second power circuit to vary a resonance frequency of a resonance circuit so that a center frequency is made variable at every delay equalizing section. With this circuit arrangement, the delay equalizing sections cascade-connected equalize the delay deviation on a batched frequency-modulated signal transmission line in the optical transmitter over a wideband, thereby reducing the delay distortion occurring due to the delay deviation.

Furthermore, in accordance with a further aspect of the present invention, there is provided an optical transmission system comprising an optical transmitter including frequency modulating means for frequency-modulating frequency-multiplexed multi-channel signals and optical modulating means for intensity-modulating signal light with batched modulated signals obtained by the frequency modulating means for optical transmission and an optical receiver for frequency-demodulating the batched frequency-modulated signal, obtained by optical/electrical-converting an optical signal transmitted from the optical transmitter, to transmit frequency-multiplexed multi-channel signals, and in the optical transmitter, a delay equalizer is provided before the optical modulating means and is composed of an inductor and a capacitor, which constitute a resonance circuit with a given resonance frequency determining a center frequency for delay equalization, and a variable resistor made variable in resistance, with a Q value of the resonance circuit being varied in accordance with a variation of the resistance of the variable resistor so that the degree of delay equalization is made variable. With this circuit arrangement, in addition to equalizing the delay deviation on the batched frequency-modulated signal transmission line, the delay equalizer can equalize the delay deviation on the batched frequency-modulated signal transmission line in the optical receiver; therefore, it is possible to reduce the delay distortion stemming from the delay deviation of the entire system from the optical transmitter to the optical receiver.

Moreover, in accordance with a further aspect of the present invention, there is provided an optical transmission system comprising an optical transmitter including frequency modulating means for frequency-modulating frequency-multiplexed multi-channel signals and optical modulating means for intensity-modulating signal light with batched modulated signals obtained by the frequency modulating means for optical transmission and an optical receiver for frequency-demodulating the batched frequency-modulated signal, obtained by optical/electrical-converting an optical signal transmitted from the optical transmitter, to transmit frequency-multiplexed multi-channel signals, and in the optical transmitter, a delay equalizer is provided before the optical modulating means and is composed of an inductor and a variable capacitor made variable in capacitance, which constitute a resonance circuit with a given resonance frequency determining a center frequency for delay equalization, and a variable resistor made variable in resistance, with the center frequency for the delay equalization is made variable in accordance with a variation of the capacitance of the variable capacitor, and a Q value of the resonance circuit being varied in accordance with a variation of the resistance of the variable resistor so that the degree of delay equalization is made variable. With this circuit arrangement, in addition to equalizing the delay deviation on the batched frequency-modulated signal transmission line, the delay equalizer can equalize the delay deviation on the batched frequency-modulated signal transmission line in the optical receiver; therefore, it is possible to reduce the delay distortion stemming from the delay deviation of the entire system from the optical transmitter to the optical receiver.

Still moreover, in accordance with a further aspect of the present invention, there is provided an optical transmission system comprising an optical transmitter including frequency modulating means for frequency-modulating frequency-multiplexed multi-channel signals and optical modulating means for intensity-modulating signal light with batched modulated signals obtained by the frequency modulating means for optical transmission and an optical receiver for frequency-demodulating the batched frequency-modulated signal, obtained by optical/electrical-converting an optical signal transmitted from the optical transmitter, to transmit frequency-multiplexed multi-channel signals, and in the optical transmitter, a delay equalizer is provided before the optical modulating means and is composed of an inductor and a capacitor, which constitute a resonance circuit with a given resonance frequency determining a center frequency for delay equalization, a PIN diode made variable in resistance, and a power circuit for controlling a current passing through the PIN diode, with a current flowing through the PIN diode being controlled to vary an internal resistance of the PIN diode so that the degree of delay equalization is made variable. With this circuit arrangement, in addition to equalizing the delay deviation on the batched frequency-modulated signal transmission line, the delay equalizer can equalize the delay deviation on the batched frequency-modulated signal transmission line in the optical receiver; therefore, it is possible to reduce the delay distortion stemming from the delay deviation of the entire system from the optical transmitter to the optical receiver.

Furthermore, in accordance with a further aspect of the present invention, there is provided an optical transmission system comprising an optical transmitter including frequency modulating means for frequency-modulating frequency-multiplexed multi-channel signals and optical modulating means for intensity-modulating signal light with batched modulated signals obtained by the frequency modulating means for optical transmission and an optical receiver for frequency-demodulating the batched frequency-modulated signal, obtained by optical/electrical-converting an optical signal transmitted from the optical transmitter, to transmit frequency-multiplexed multi-channel signals, and in the optical transmitter, a delay equalizer is provided before the optical modulating means and is composed of an inductor and a voltage variable capacitor made variable in capacitance through voltage control, which constitute a resonance circuit with a given resonance frequency determining a center frequency for delay equalization, a variable resistor made variable in resistance, and a power circuit for controlling a voltage across the voltage variable capacitor, with a Q value of the resonance circuit being varied in accordance with a variation of the resistance of the variable resistor so that the degree of delay equalization is made variable, and the voltage across the voltage variable capacitor being controlled to vary a resonance frequency of the resonance circuit so that the center frequency for the delay equalization is made variable. With this circuit arrangement, in addition to equalizing the delay deviation on the batched frequency-modulated signal transmission line, the delay equalizer can equalize the delay deviation on the batched frequency-modulated signal transmission line in the optical receiver; therefore, it is possible to reduce the delay distortion stemming from the delay deviation of the entire system from the optical transmitter to the optical receiver.

Still furthermore, in accordance with a further aspect of the present invention, there is provided an optical transmission system comprising an optical transmitter including frequency modulating means for frequency-modulating frequency-multiplexed multi-channel signals and optical modulating means for intensity-modulating signal light with batched modulated signals obtained by the frequency modulating means for optical transmission and an optical receiver for frequency-demodulating the batched frequency-modulated signal, obtained by optical/electrical-converting an optical signal transmitted from the optical transmitter, to transmit frequency-multiplexed multi-channel signals, and in the optical transmitter, a delay equalizer is provided before the optical modulating means and is composed of an inductor and a voltage variable capacitor made variable in capacitance through voltage control, which constitute a resonance circuit with a given resonance frequency determining a center frequency for delay equalization, and a PIN diode made variable in resistance, a first power circuit for controlling a current flowing through the PIN diode and a second power circuit for controlling a voltage across the voltage variable capacitor, with the current flowing through the PIN diode being controlled by the first power circuit to vary an internal resistance of the PIN diode so that the degree of delay equalization is made variable, while in the delay equalizer, the voltage across the voltage variable capacitor being controlled by the second power circuit to vary a resonance frequency of the resonance circuit so that the center frequency for the delay equalization is made variable. With this circuit arrangement, in addition to equalizing the delay deviation on the batched frequency-modulated signal transmission line, the delay equalizer can equalize the delay deviation on the batched frequency-modulated signal transmission line in the optical receiver; therefore, it is possible to reduce the delay distortion stemming from the delay deviation of the entire system from the optical transmitter to the optical receiver.

In addition, in accordance with a further aspect of the present invention, there is provided an optical transmission system comprising an optical transmitter including frequency modulating means for frequency-modulating frequency-multiplexed multi-channel signals and optical modulating means for intensity-modulating signal light with batched modulated signals obtained by the frequency modulating means for optical transmission and an optical receiver for frequency-demodulating the batched frequency-modulated signal, obtained by optical/electrical-converting an optical signal transmitted from the optical transmitter, to transmit frequency-multiplexed multi-channel signals, and in the optical transmitter, a delay equalizer is provided before the optical modulating means and is composed of a plurality of delay equalizing sections, each including an inductor, a capacitor and a variable resistor, cascade-connected between input and output terminals, with a resistance of the variable resistor of each of the delay equalizing sections being controlled individually so that the degree of delay equalization is made variable according to center frequency of each of the delay equalizing sections. With this circuit arrangement, in addition to equalizing the delay deviation on the batched frequency-modulated signal transmission line, the plurality of delay equalizing sections of the delay equalizer in the optical transmitter can equalize the delay deviation on the batched frequency-modulated signal transmission line in the optical receiver over a wideband; therefore, it is possible to reduce the delay distortion stemming from the delay deviation of the entire system from the optical transmitter to the optical receiver.

Still additionally, in accordance with a further aspect of the present invention, there is provided an optical transmission system comprising an optical transmitter including frequency modulating means for frequency-modulating frequency-multiplexed multi-channel signals and optical modulating means for intensity-modulating signal light with batched modulated signals obtained by the frequency modulating means for optical transmission and an optical receiver for frequency-demodulating the batched frequency-modulated signal, obtained by optical/electrical-converting an optical signal transmitted from the optical transmitter, to transmit frequency-multiplexed multi-channel signals, and in the optical transmitter, a delay equalizer is provided before the optical modulating means and is composed of a plurality of delay equalizing sections, each including an inductor, a variable capacitor and a variable resistor, cascade-connected between input and output terminals, with a capacitance of the variable capacitor of each of the delay equalizing sections being control individually to vary a resonance frequency of a resonance circuit so that a center frequency for delay equalization is made variable, and a resistance of the variable resistor of each of the delay equalizing sections being controlled individually so that the degree of delay equalization is made variable according to center frequency of each of the delay equalizing sections. With this circuit arrangement, in addition to equalizing the delay deviation on the batched frequency-modulated signal transmission line, the plurality of delay equalizing sections of the delay equalizer in the optical transmitter can equalize the delay deviation on the batched frequency-modulated signal transmission line in the optical receiver over a wideband; therefore, it is possible to reduce the delay distortion stemming from the delay deviation of the entire system from the optical transmitter to the optical receiver.

In the foregoing optical transmission system, each of the delay equalizing sections includes a PIN diode serving as the variable resistor and a power circuit for controlling a current value flowing through the PIN diode, with the current flowing through the PIN diode of each of the delay equalizing sections being controlled to vary the internal resistance of the PIN diode so that the degree of delay equalization is made variable. With this circuit arrangement, in addition to equalizing the delay deviation on the batched frequency-modulated signal transmission line, the plurality of delay equalizing sections of the delay equalizer in the optical transmitter can equalize the delay deviation on the batched frequency-modulated signal transmission line in the optical receiver over a wideband; therefore, it is possible to reduce the delay distortion stemming from the delay deviation of the entire system from the optical transmitter to the optical receiver.

In addition, in the foregoing optical transmission system, each of the delay equalizing sections includes a voltage variable capacitor made variable in capacitance through voltage control and serving as the variable capacitor and a power circuit for controlling a voltage across the voltage variable capacitor, with the voltage value across the voltage variable capacitor of each of the delay equalizing sections being controlled to vary a resonance frequency of a resonance circuit so that a center frequency is made variable according to delay equalizing section. With this circuit arrangement, in addition to equalizing the delay deviation on the batched frequency-modulated signal transmission line, the plurality of delay equalizing sections of the delay equalizer in the optical transmitter can equalize the delay deviation on the batched frequency-modulated signal transmission line in the optical receiver over a wide band; therefore, it is possible to reduce the delay distortion stemming from the delay deviation of the entire system from the optical transmitter to the optical receiver.

Still additionally, in the foregoing optical transmission system, each of the delay equalizing sections includes a PIN diode serving as the variable resistor, a first power circuit for controlling a current flowing through the PIN diode, a voltage variable capacitor made variable in capacitance through voltage control and serving as the variable capacitor, and a second power circuit for controlling a voltage across the voltage variable capacitor, with the current flowing the PIN diode of each of the delay equalizing sections being controlled by the first power circuit to vary the internal resistance of the PIN diode so that the degree of delay equalization is made variable according to delay equalizing section, and the voltage across the voltage variable capacitor of each of the delay equalizing sections being controlled by the second power circuit to vary a resonance frequency of a resonance circuit so that a center frequency is made variable according to delay equalizing section. With this circuit arrangement, in addition to equalizing the delay deviation on the batched frequency-modulated signal transmission line, the plurality of delay equalizing sections of the delay equalizer in the optical transmitter can equalize the delay deviation on the batched frequency-modulated signal transmission line in the optical receiver over a wideband; therefore, it is possible to reduce the delay distortion stemming from the delay deviation of the entire system from the optical transmitter to the optical receiver.

### BRIEF DESCRIPTION OF THE DRAWINGS

Other objects and features of the present invention will become more readily apparent from the following detailed description of the preferred embodiments taken in conjunction with the accompanying drawings in which:

FIG. 1 is a circuit diagram showing an arrangement of an delay equalizer according to a first embodiment of the present invention;

FIG. 2 is an illustration of a variation characteristic of delay equalization in a delay equalizer according to the invention;

FIG. 3 is a circuit diagram showing an arrangement of an delay equalizer according to a second embodiment of the present invention;

FIG. 4 is an illustration of a variation characteristic of a center frequency in a delay equalizer according to the invention;

FIG. 5 is a circuit diagram showing an arrangement of an delay equalizer according to a third embodiment of the present invention;

FIG. 6 is a circuit diagram showing an arrangement of an delay equalizer according to a fourth embodiment of the present invention;

FIG. 7 is a circuit diagram showing an arrangement of an delay equalizer according to a fifth embodiment of the present invention;

FIG. 8 is a circuit diagram showing an arrangement of an delay equalizer according to a sixth embodiment of the present invention;

FIG. 9 is an illustration of a variation characteristic of a delay characteristic in the delay equalizer according to the sixth embodiment of the invention;

FIG. 10 is a characteristic illustration of an example of a variation state of a delay characteristic in the delay equalizer according to the sixth embodiment of the invention;

FIG. 11 is a characteristic illustration of an example of a variation state of a delay characteristic in the delay equalizer according to the sixth embodiment of the invention;

FIG. 12 is a circuit diagram showing an arrangement of an delay equalizer according to a seventh embodiment of the present invention;

FIG. 13 is a circuit diagram showing an arrangement of an delay equalizer according to an eighth embodiment of the present invention;

FIG. 14 is a circuit diagram showing an arrangement of an delay equalizer according to a ninth embodiment of the present invention;

FIG. 15 is a circuit diagram showing an arrangement of an delay equalizer according to a tenth embodiment of the present invention;

FIG. 16 is a block diagram showing a configuration of an optical transmitter according to the invention;

FIG. 17 is a block diagram showing a configuration of an optical transmission system using an optical transmitter according to the invention;

FIG. 18 is a circuit diagram showing an arrangement of a delay equalizer in the related art; and

FIG. 19 is a block diagram showing a configuration of an optical transmission system using a related art optical transmitter.

### DESCRIPTION OF THE PREFERRED EMBODIMENTS

Embodiments of the present invention will be described hereinbelow with reference to the drawings. The parts substantially identical or corresponding in function to those described above in the related art will be marked with the same reference numerals.

(Delay Equalizer According to First Embodiment)

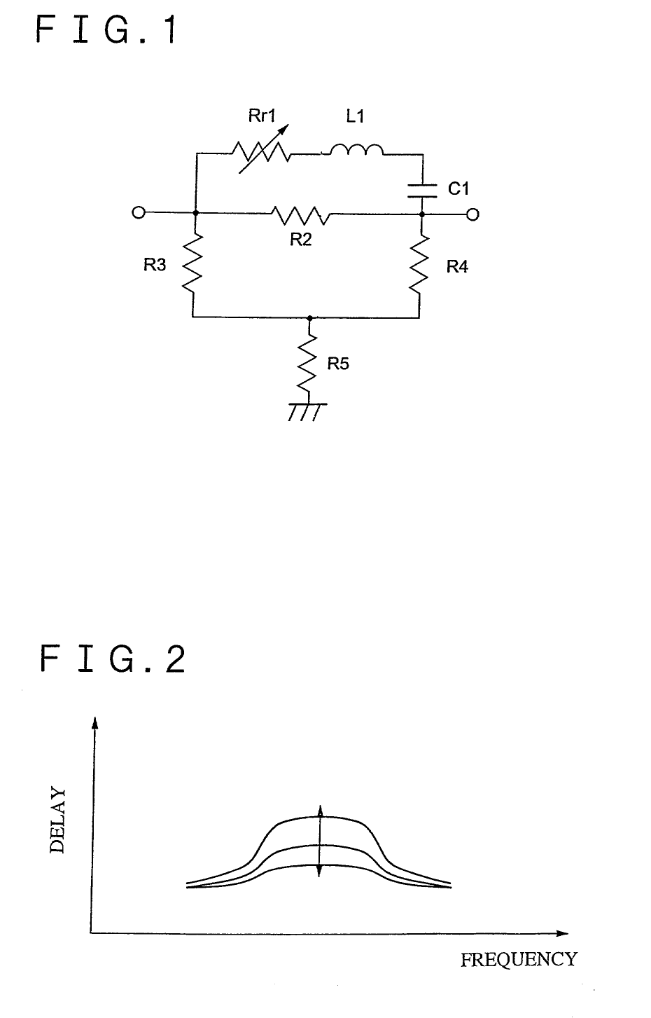

FIG. 1 is a circuit diagram showing an arrangement of a delay equalizer according to a first embodiment of the present invention. This delay equalizer is made up of a series circuit comprising a variable resistor Rr1, inductor L1 and a capacitor C1 and a series circuit comprising a resistor R2 and resistors R3, R4 connected in parallel therewith, and a resistor R5 placed between the resistors R3 and R4 and grounded, between input and output terminals.

A description will be given hereinbelow of a circuit operation in this circuit arrangement. In this circuit arrangement, a resonance frequency of a resonance circuit comprising the inductor L1 and the capacitor C1 determines a center frequency in a delay characteristic which causes variation of a delay characteristic. FIG. 2 is a delay characteristic illustration of variation of quantity of delay equalization in this circuit arrangement, where the horizontal axis represents frequencies and the vertical axis represents delay quantities. When the resistance of the variable resistor Rr1 varies by being controlled from the external, a variation of the Q value of the resonance circuit occurs as shown in the illustration.

As described above, according to this embodiment, the control from the external produces a variation of the delay equalization quantity, thus flexibly coping with variations of delay characteristics in a transmission line so that a delay equalization characteristic suitable for a delay characteristic of a transmission line is attainable.

(Delay Equalizer According to Second Embodiment)

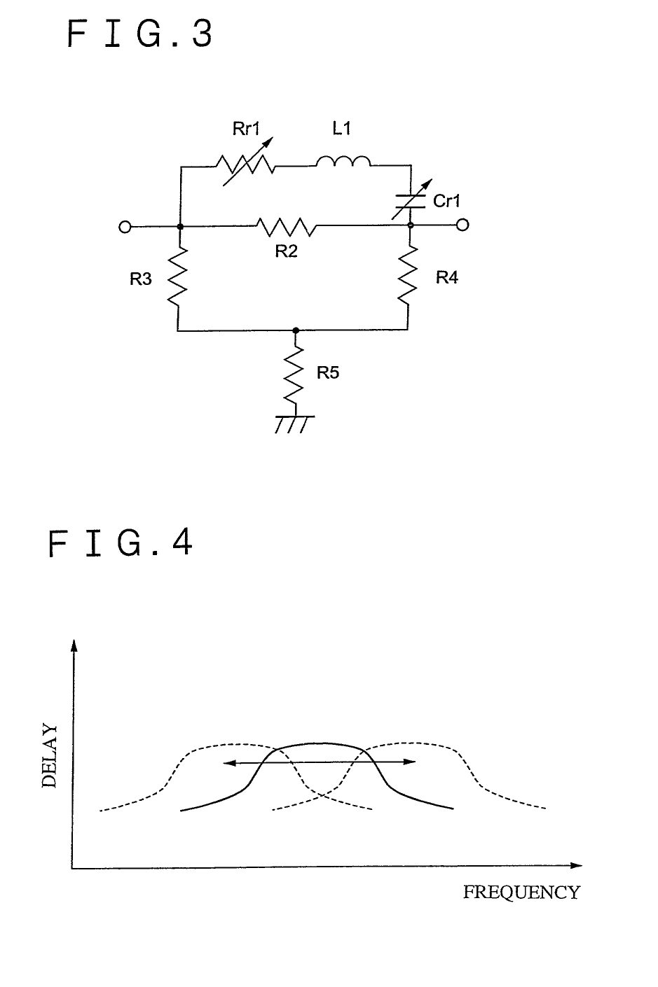

FIG. 3 is a circuit diagram showing an arrangement of a delay equalizer according to a second embodiment of the present invention. In FIG. 3, the same parts as those in the first embodiment are marked with the same reference numerals, and the detailed description thereof will be omitted for brevity. In the second embodiment, a variable capacitor (variable-capacitance capacitor) Cr1 is used in place of the capacitor C1 in the first embodiment.

In an operation of this circuit arrangement, the capacitance of the capacitor Cr1 is varied by being controlled from the external to vary the resonance frequency of a resonance circuit comprising the inductor L1 and the capacitor Cr1, thereby varying the center frequency itself to vary the delay characteristic as shown in the characteristic illustration of FIG. 4. In addition, the resistance of the variable resistor Rr1 is varied by being controlled from the external, thereby varying the Q value of the resonance circuit so that the delay equalization quantity varies as shown in the characteristic illustration of FIG. 2.

As described above, according to this embodiment, the center frequency is varied by being controlled from the external to vary the delay characteristic, and the delay equalization quantity is varied in like manner, which permits coping more flexibly with the variation of the delay characteristic of a transmission line as compared with the delay equalizing circuit according to the first embodiment.

(Delay equalizer According to Third Embodiment)

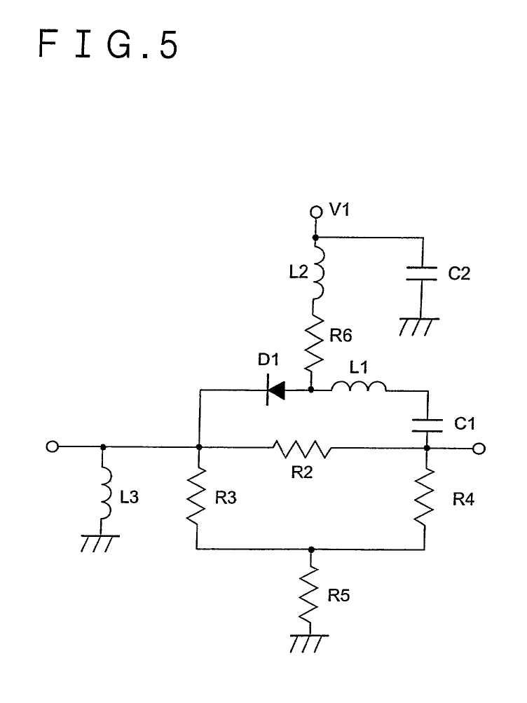

FIG. 5 is a circuit diagram showing an arrangement of a delay equalizer according to a third embodiment of the present invention. In FIG. 5, the same parts as those in the first and second embodiments are marked with the same reference numerals, and the detailed description thereof will be omitted for brevity. In the third embodiment, a PIN diode D1 is used in place of the variable resistor Rr1 in the first embodiment, and a power circuit is additionally provided to supply a current to this PIN diode D1. This power circuit is designed to supply power from a power source V1 through an inductor L2 and a resistor R6 to the PIN diode D1. A capacitor C2 is connected in parallel with the inductor L2, and an inductor L3, whose one end is grounded, is connected at the other end to an input terminal.

In an operation of the aforesaid circuit arrangement, a center frequency causing a variation of the delay characteristic is determined by the resonance frequency of the resonance circuit comprising the inductor L1 and the capacitor C1. In addition, when a supply voltage V1 is varied from the external, a value of current flowing through the PIN diode D1 varies to control an internal resistance value of the PIN diode D1 so that the Q value of the resonance circuit varies to vary the delay equalization quantity as shown in the characteristic illustration of FIG. 2.

As described above, according to this embodiment, the delay equalization quantity is varied with a simple circuit in which voltage control is implemented from the external, thus coping flexibly with variation of the delay characteristic of a transmission line to provide a delay equalization characteristic suitable for the delay characteristic of the transmission line.

(Delay Equalizer According to Fourth Embodiment)

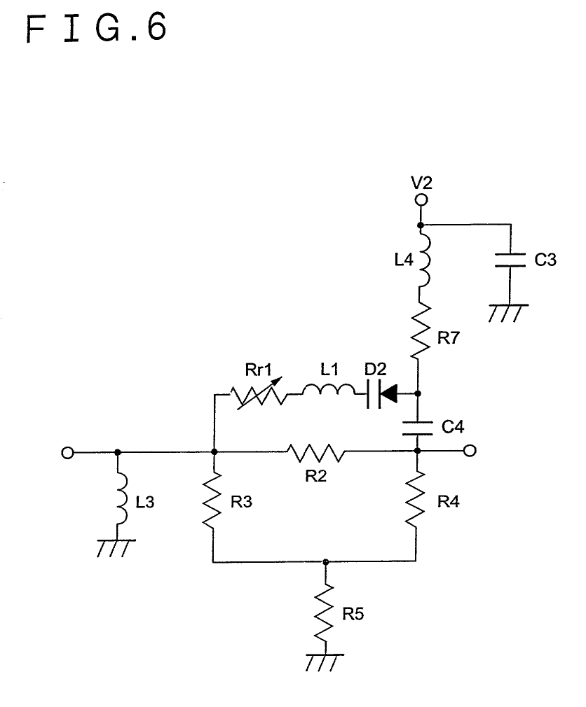

FIG. 6 is a circuit diagram showing an arrangement of a delay equalizer according to a fourth embodiment of the present invention. In FIG. 6, the same parts as those in the first to third embodiments are marked with the same reference numerals, and the detailed description thereof will be omitted for brevity. In the fourth embodiment, a voltage variable capacitor (voltage variable-capacitance capacitor) C2 and a capacitor C4 are used in place of the variable capacitor Cr1 in the second embodiment, and a power circuit for varying a voltage to the voltage variable capacitor D2 is provided which is shown as being composed of an inductor L4, a capacitor C3 and a resistor R7.

In an operation of the above-mentioned circuit arrangement, a voltage to the voltage variable capacitor D2 is varied by changing a supply voltage V2 from the external so that the resonance frequency of the resonance circuit comprising the inductor L1, the voltage variable capacitor D2 and the capacitor C4 varies, thereby varying the center frequency for changing the delay characteristic as shown in FIG. 4. In addition, the resistance of the variable resistor Rr1 is controlled from the external to vary, thereby varying the Q value of the resonance circuit for changing the delay equalization quantity as shown in FIG. 2.

As described above, according to this embodiment, a simple circuit arrangement is put to use, nevertheless the delay equalization quantity is varied through voltage control from the external to change the center frequency, and the control of the delay equalization quantity from the external permits coping flexibly with a variation of the delay characteristic of a transmission line and offering a delay equalization characteristic suitable for the delay characteristic of the transmission line.

(Delay Equalizer According to Fifth Embodiment)

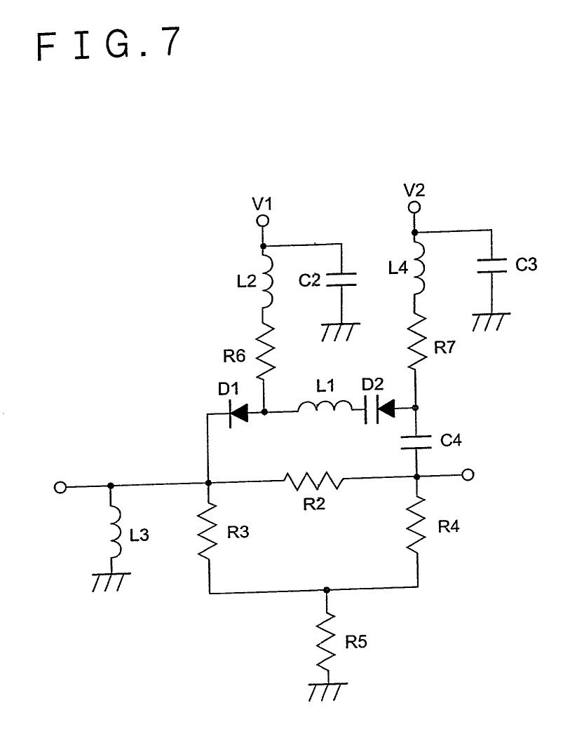

FIG. 7 is a circuit diagram showing an arrangement of a delay equalizer according to a fifth embodiment of the present invention. In FIG. 7, the same parts as those in the above-described first to fourth embodiments are marked with the same reference numerals, and the detailed description thereof will be omitted for simplicity. In the fifth embodiment, a PIN diode D1 is used in place of the variable resistor Rr1 in the second embodiment, and a power circuit for supplying a current to this diode D1 is provided which is shown as comprising inductors L2, L3, a capacitor C2 and a resistor R6. In addition, a voltage variable capacitor D2 and a capacitor C4 are used in place of the variable capacitor Cr1, and a power circuit for varying the voltage to be applied to the voltage variable capacitor D2 is provided which is shown as comprising an inductor L4, a capacitor C3 and a resistor R7.

In an operation of this circuit arrangement, when a supply voltage V2 is varied from the external, the voltage of the voltage variable capacitor D2 varies, thus causing a variation of the resonance frequency of the resonance circuit comprising the inductor L1, the voltage variable capacitor D2 and the capacitor C4 so that the center frequency, which varies (determines) the delay characteristic, is made variable as shown in the characteristic illustration of FIG. 4. Moreover, when a supply voltage V1 is varied from the external, the value of a current flowing through the PIN diode D1 varies to control the value of the internal resistance of the PIN diode D1 so that the Q value of the resonance circuit varies to vary the delay equalization quantity as shown in the characteristic illustration of FIG. 2.

As described above, according to this embodiment, the delay equalization quantity is varied through two systems of voltage control from the external to change the center frequency of the delay characteristic, and the control of the delay equalization quantity from the external permits coping flexibly with a variation of the delay characteristic of a transmission line, thus offering a delay equalization characteristic optimal for the delay characteristic of the transmission line with a simple circuit arrangement.

(Delay Equalizer According to Sixth Embodiment)

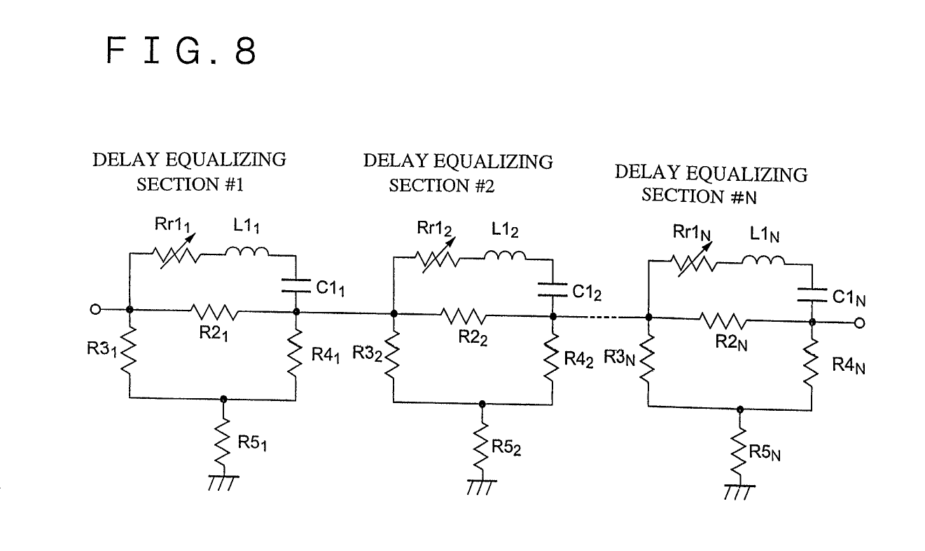

FIG. 8 is a circuit diagram showing an arrangement of a delay equalizer according to a sixth embodiment of the present invention. In FIG. 8, the same parts as those in the above-described first to fifth embodiments are marked with the same reference numerals, and the detailed description thereof will be omitted for simplicity. In the sixth embodiment, N (three in the illustration) delay equalizers each corresponding to the delay equalizer according to the first embodiment are cascade-connected to form N-stage delay equalizing sections #1, #2, . . . , #N. The parts constituting each of the delay equalizing sections are marked with the corresponding subscripts 1, 2, . . . , N in each stage.

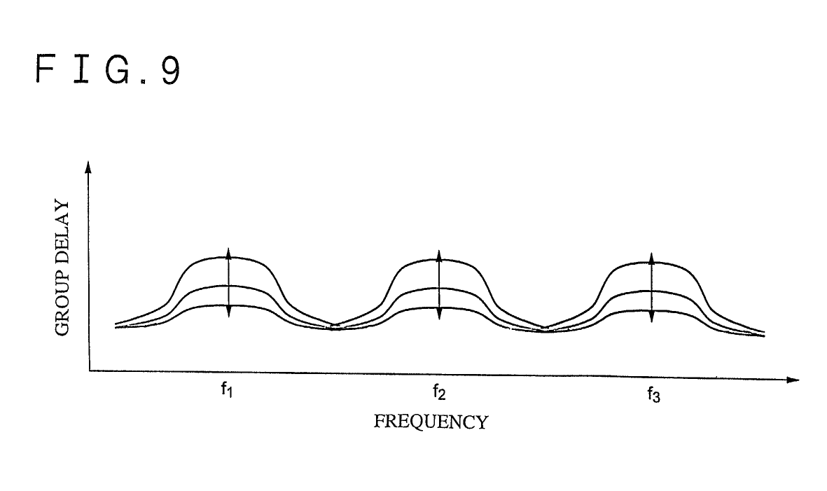

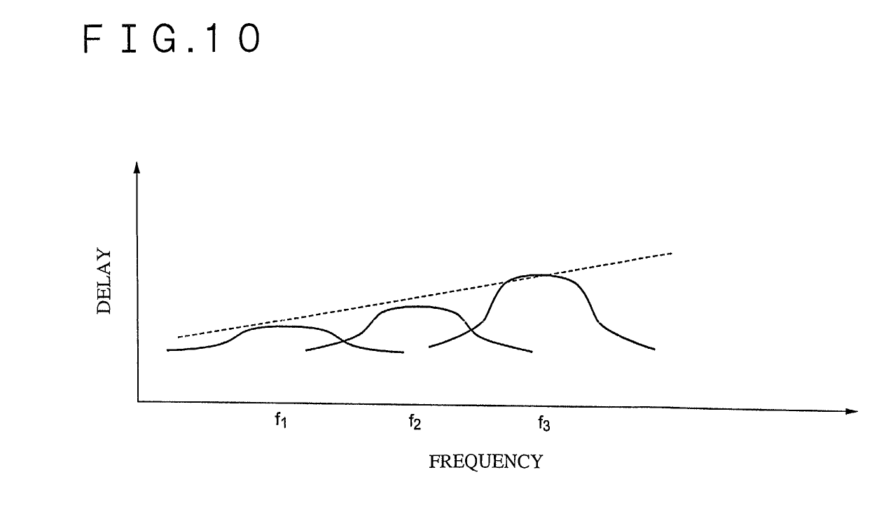

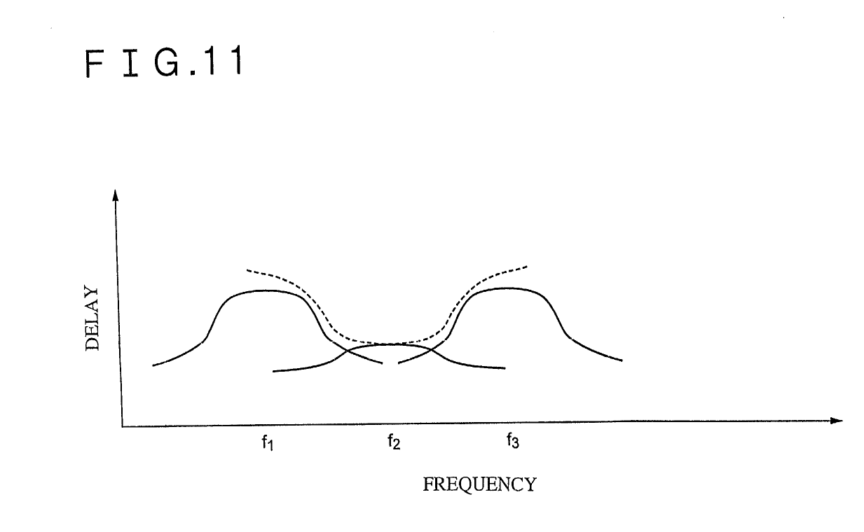

In an operation of this circuit arrangement, the resonance frequencies of the resonance circuits, each comprising the inductor L1 and the capacitor C1, in the delay equalizing sections #1, #2, . . . , #N are made to be different from each other. Accordingly, the delay characteristic can be changed with different frequencies f1, f2, f3, . . . , fN in the respective delay equalizing sections #1, #2 and #N as shown in the characteristic illustration of FIG. 9. In addition, when, in each of the delay equalizing sections #1, #2, . . . , #N, the resistance value of the variable resistor Rr1 is varied by being independently controlled from the external to vary the Q value of the corresponding resonance circuit, the delay equalization quantity can be varied independently with the frequencies f1, f2, f3 (fN) as shown in FIG. 9. For example, as shown in the characteristic illustration of FIG. 10, it is possible to increase the delay quantity as the frequency becomes higher, or as shown in the characteristic illustration of FIG. 11, it is possible to decrease only the delay quantity corresponding to the frequency f2. Thus, this circuit arrangement can provide a variety of delay equalization characteristics over a wideband of frequencies.

As described above, according to this embodiment, in each of the delay equalizing sections, the delay equalization quantity is separately varied through the control from the external, which permits coping flexibly with variation of delay characteristic of a transmission line over a wide band, thus offering a delay equalization characteristic suitable for the delay characteristic of the transmission line.

(Delay Equalizer According to Seventh Embodiment)

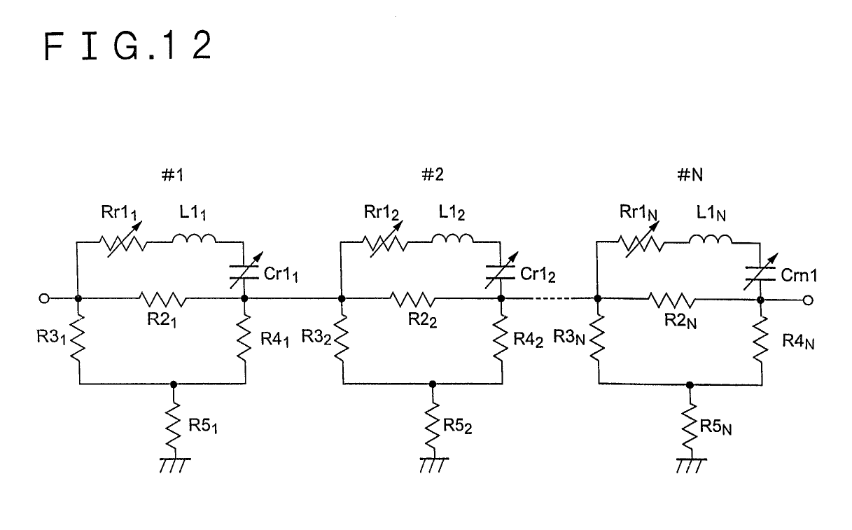

FIG. 12 is a circuit diagram showing an arrangement of a delay equalizer according to a seventh embodiment of the present invention. In FIG. 12, the same parts as those in the above-described first to sixth embodiments are marked with the same reference numerals, and the detailed description thereof will be omitted for simplicity. In the seventh embodiment, a variable capacitor Cr1 is used in place of the capacitor C1 in each of the delay equalizing sections in the sixth embodiment.

In an operation of this circuit arrangement, in each of the delay equalizing sections #1, #2, . . . , #N, when the capacitance of the variable capacitor Cr1 is varied by being controlled from the external, the resonance frequency of the resonance circuit comprising the inductor L1 and the variable capacitor Cr1 varies separately so that the delay characteristic can be varied with the corresponding one of the different frequencies f1, f2, f3 (fN) as shown in the characteristic illustration of FIG. 9. In addition, in each of the delay equalizing sections #1, #2, . . . , #N, when the resistance value of the variable resistor Rr1 is varied independently by control from the external, the Q value of the resonance circuit varies, thus accomplishing the independent variation of the delay equalization quantity with the corresponding one of the frequencies f1, f2, f3 (fN) as shown in the characteristic illustration of FIG. 9. Accordingly, this can provide a variety of delay equalization characteristics over a wideband of frequencies as shown in the characteristic illustrations of FIGS. 10 and 11.

As described above, according to this embodiment, the control from the external can vary the delay equalization quantity at every delay equalizing section, and further can vary the center frequency which determines the delay characteristic. Accordingly, it is possible to cope flexibly with a variation of the delay characteristic of a transmission line over a wider band as compared with the above-described sixth embodiment, thus offering a delay equalization characteristic suitable for the delay characteristic of the transmission line.

(Delay Equalizer According to Eighth Embodiment)

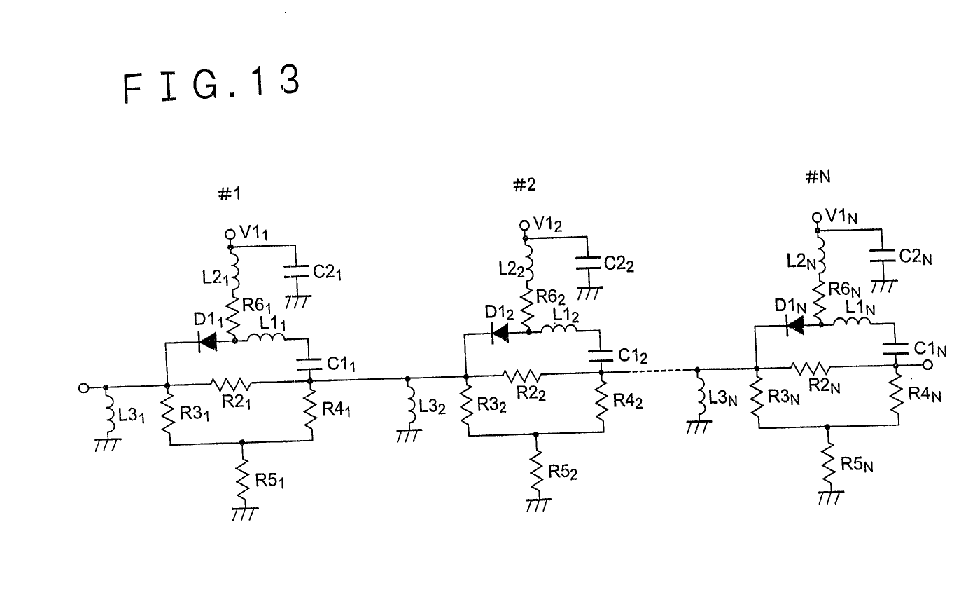

FIG. 13 is a circuit diagram showing an arrangement of a delay equalizer according to an eighth embodiment of the present invention. In FIG. 13, the same parts as those in the above-described first to seventh embodiments are marked with the same reference numerals, and the detailed description thereof will be omitted for simplicity. In the eighth embodiment, in each of the delay equalizing sections #1, #2, . . . , #N, a PIN diode D1 is used in place of the variable resistor Rr1 in the delay equalizer 2 according to the sixth embodiment and a power circuit comprising the inductors L2, L3, the capacitor C2 and the resistor R6 is provided to supply a current to the PIN diode D1.

In an operation of this circuit arrangement, in the delay equalizing sections #1, #2, . . . , #N, the resonance frequencies of the resonance circuits each comprising the inductor L1 and the capacitor C1 are set to be different from each other, in which case the delay characteristic can be changed with different frequencies f1, f2, f3 (fN) as shown in the characteristic illustration of FIG. 9. In addition, the supply voltage V1 of each of the delay equalizing sections #1, #2, . . . , #N is varied independently from the external to vary the value of the current flowing through the PIN diode D1 for independently controlling the internal resistance value of the PIN diode D1, so the Q value of the resonance circuit varies, thereby independently varying the delay equalization as shown in the characteristic illustration of FIG. 9. Whereupon, it is possible to provide a variety of delay equalization characteristics over a wideband of frequencies as shown in FIGS. 10 and 11.

As described above, according to this embodiment, the delay equalization quantity is varied in each of the delay equalizing sections through voltage control from the external, which permits coping flexibly with a variation of the delay characteristic of a transmission line over a wide band, thus offering a delay equalization characteristic suitable for the delay characteristic of the transmission line with a simple circuit arrangement.

(Delay Equalizer According to Ninth Embodiment)

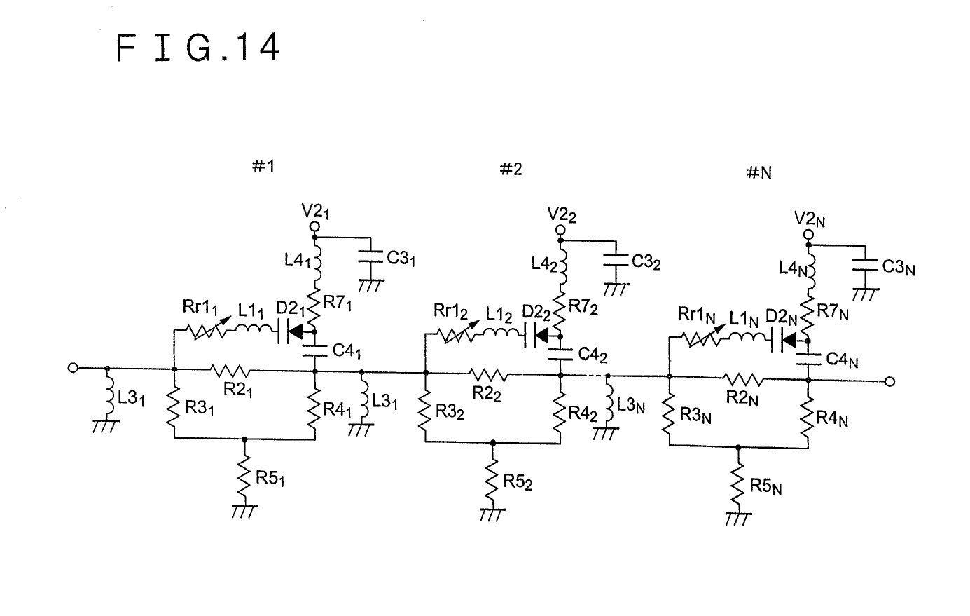

FIG. 14 is a circuit diagram showing an arrangement of a delay equalizer according to a ninth embodiment of the present invention. In FIG. 14, the same parts as those in the above-described first to eighth embodiments are marked with the same reference numerals, and the detailed description thereof will be omitted for simplicity. In the ninth embodiment, a voltage variable capacitor D2 and a capacitor C4 are used in place of the variable capacitor Cr1 in each of the delay equalizing sections #1, #2, . . . , #N of the delay equalizer according to the seventh embodiment. In addition, in each of the delay equalizing sections #1, #2, . . . , #N, a power circuit for varying the voltage to the voltage variable capacitor D2 is provided which is composed of the inductor L4, the capacitor C3 and the resistor R7.

In an operation of this circuit arrangement, in each of the delay equalizing sections #1, #2, . . . , #N, when the supply voltage V2 is varied from the external, the voltage to the voltage variable capacitor D2 varies, thereby varying the resonance frequency of the resonance circuit comprising the inductor L1, the voltage variable capacitor D2 and the capacitor C4, in which case each of the center frequencies f1, f2, f3 (fN) shifts to vary the delay characteristic of each of the delay equalizing sections as shown in the characteristic illustration of FIG. 9. In addition, in each of the delay equalizing sections #1, #2, . . . , #N, when the resistance value of the variable resistor Rr1 is varied independently through the control from the external, the Q value of the resonance circuit varies, thereby independently varying the delay equalization quantity as shown in the characteristic illustration of FIG. 9. Accordingly, this can provide a variety of delay equalization characteristics over a wide band of frequencies as shown in FIGS. 10 and 11.

As described above, according to this embodiment, although a simple circuit arrangement is put to use, the center frequencies f1, f2, f3 (fN), capable of varying the delay characteristic of each of the delay equalizing sections #1, #2, . . . , #N, can be varied through the voltage control from the external and the delay equalization quantity of each of the delay equalizing sections #1, #2, . . . , #N can be varied independently through the control from the external, which varies the delay equalization quantity over a wide band of frequencies, permits coping flexibly with a variation of the delay characteristic of a transmission line over a wide band, and provides a delay equalization characteristic suitable for the delay characteristic of the transmission line.

(Delay Equalizer According to Tenth Embodiment)

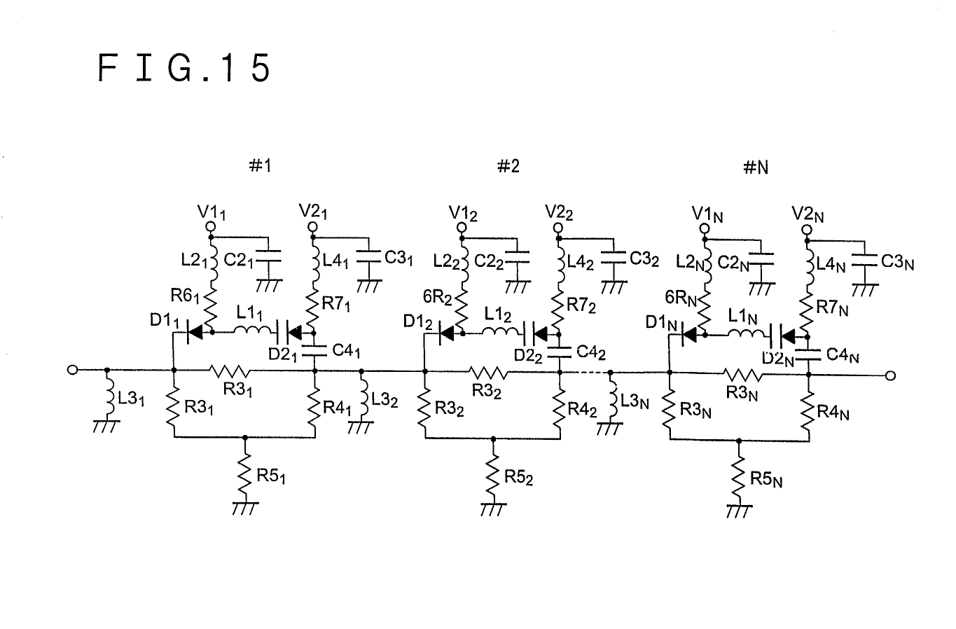

FIG. 15 is a circuit diagram showing an arrangement of a delay equalizer according to a tenth embodiment of the present invention. In FIG. 15, the same parts as those in the above-described first to ninth embodiments are marked with the same reference numerals, and the detailed description thereof will be omitted for simplicity. In the tenth embodiment, in each of the delay equalizing sections #1, #2, . . . , #N, the variable resistor Rr1 in the seventh embodiment is replaced with a PIN diode D1, and a power circuit comprising the inductors L2, L3, the capacitor C2 and the resistor R6 is provided in order to supply a current to the PIN diode D1. In addition, in each of the delay equalizing sections #1, #2, . . . , #N, a variable capacitor Cr1 is constructed with the voltage variable capacitor D2 and the capacitor C4, and a power circuit comprising the inductor L4, the capacitor C3 and the resistor R7 is further provided to vary the voltage to the voltage variable capacitor D2.

In an operation, in each of the delay equalizing sections #1, #2, . . . , #N, the supply voltage V2 is varied from the external, the voltage to the voltage variable capacitor D2 varies to vary the resonance frequency of the resonance circuit comprising the inductor L1, the voltage variable capacitor D2 and the capacitor C4, so each of the center frequencies fi, f2 and f3 (fN) becomes variable to change the delay characteristic of each of the delay equalizing sections #1, #2, . . . , #N as shown in FIG. 9. In addition, in each of the delay equalizing sections #1, #2, . . . , #N, when the supply voltage V1 is varied independently from the external, the value of the current flowing through the PIN diode D1 varies to independently control the internal resistance of the PIN diode D1, thus varying the delay equalization quantity independently as shown in the characteristic illustration of FIG. 9. Accordingly, it is possible to provide a variety of delay equalization characteristics over a wide band of frequencies as shown in FIGS. 10 and 11.

As described above, according to this embodiment, although a simple circuit arrangement is put to use, the center frequencies f1, f2, f3 (fN), capable of varying the delay characteristic of each of the delay equalizing sections #1, #2, . . . , #N, can be varied through the voltage control from the external and the delay equalization quantity of each of the delay equalizing sections #1, #2, . . . , #N can be varied independently through the voltage control from the external, which varies the delay equalization quantity over a wide band of frequencies, permits coping flexibly with a variation of the delay characteristic of a transmission line over a wide band, and provides a delay equalization characteristic suitable for the delay characteristic of the transmission line.

(First Optical Transmitter According to the Invention)

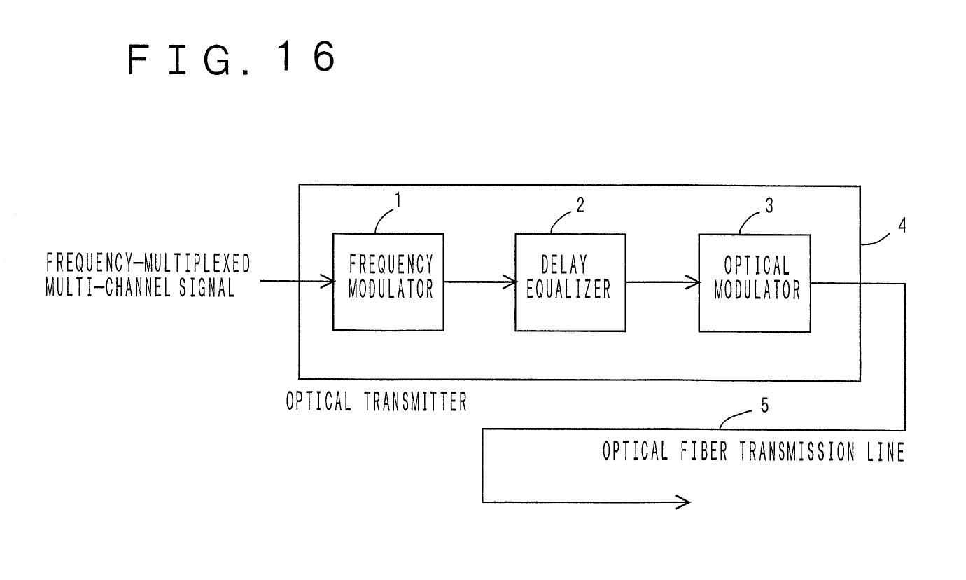

FIG. 16 is a block diagram showing a configuration of an optical transmitter according to an eleventh embodiment of the present invention. In FIG. 16, a delay equalizer 2 of an optical transmitter 4 has the same arrangement as that of the delay equalizer according to the first embodiment (see FIG. 1), and the description thereof will be omitted for brevity. This optical transmitter 4 further comprises a frequency modulator (which will be referred to hereinafter as an “FM modulator”) 1 and an optical modulator 3.

A description will be given hereinbelow of this configuration. Frequency-multiplexed multi-channel signals are inputted to the optical transmitter 4 and frequency-modulated (which will be referred to hereinafter as “FM-modulated”) in the FM modulator 1 in batches. The batched FM-modulated signal obtained by the FM modulator 1 is inputted to the delay equalizer 2 to produce and add a delay equalization quantity needed for equalizing a delay deviation in a batched FM-modulated signal transmission line existing within the optical transmitter 4, and then outputted to the optical modulator 3 where signal light is intensity-modulated and optically transmitted through an optical fiber transmission line 5.

As described above, the delay equalizer 2 can equalize the delay deviation on the batched FM-modulated signal transmission line in the optical transmitter 4, thus reducing the delay distortion stemming from the delay deviation so that high-quality transmission of frequency-multiplexed multi-channel signals is realizable.

(First Optical Transmission System Using Optical Transmitter According to the Invention)

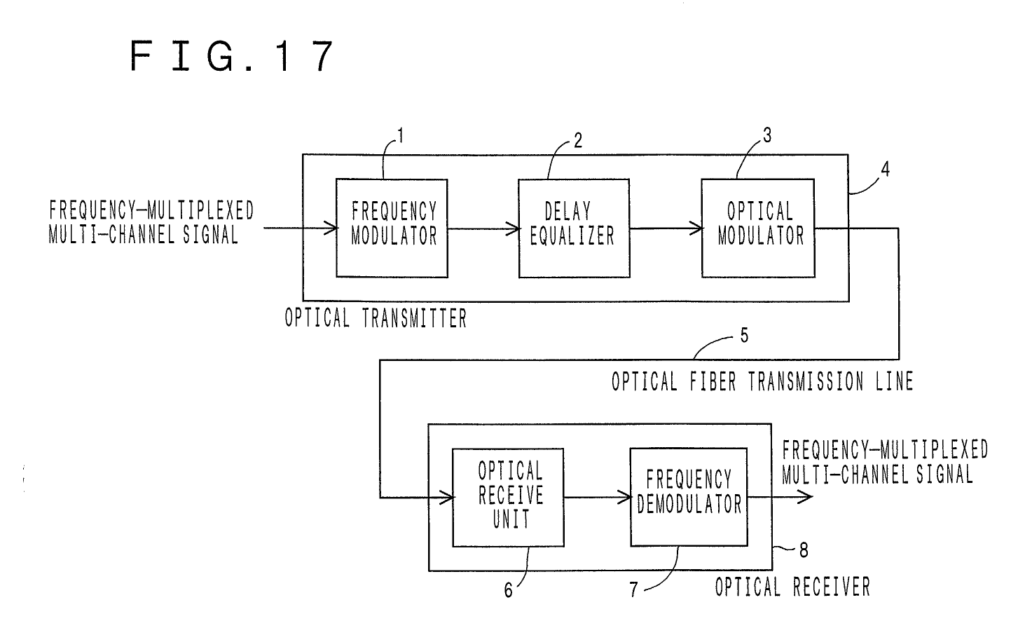

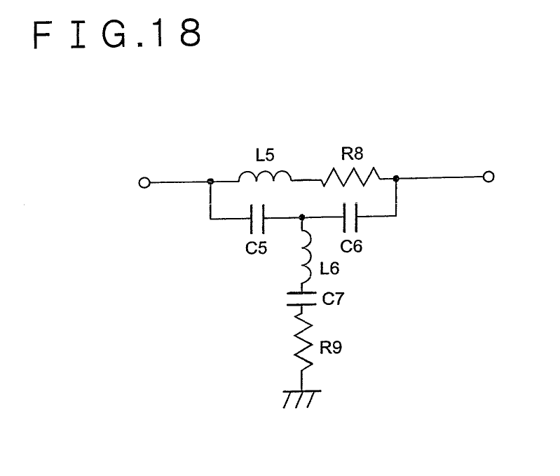

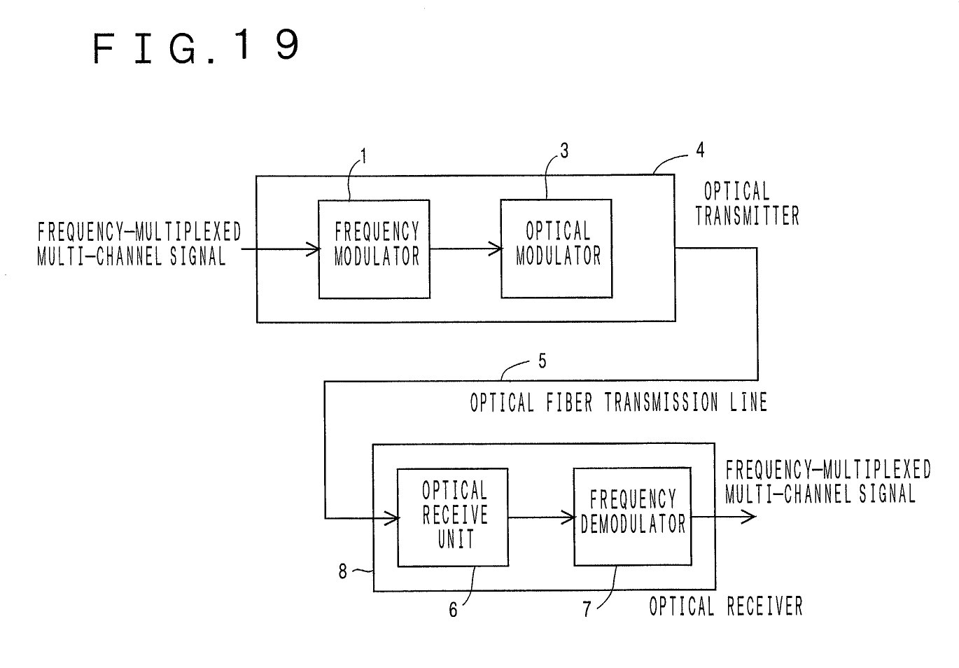

FIG. 17 is a block diagram showing a configuration of an optical transmission system according to a twelfth embodiment of the present invention. In FIG. 17, the same parts as those of the optical transmitter according to the eleventh embodiment are marked with the same reference numerals, and the detailed description thereof will be omitted for brevity. In this optical transmission system, an optical transmitter 4 is composed of an FM modulator 1, a delay equalizer 2 according to the above-described first embodiment (see FIG. 1), and an optical modulator 3, while an optical receiver 8 is composed of an optical receive unit 6 and a frequency demodulator (FM demodulator) 8.

A description will be given hereinbelow of an operation of the optical transmission system thus constructed. Frequency-multiplexed multi-channel signals inputted to the optical transmitter 4 are FM-modulated in the FM modulator 1 in batches. The batched FM-modulated signals obtained in this way are inputted to the delay equalizer 2 which produces and adds a delay equalization quantity needed for equalizing the entire delay deviation on the batched FM-modulated signal transmission line existing within the optical transmitter 4, an optical fiber transmission line 5 and the batched FM-modulated signal transmission line existing within the optical receiver 8, and then outputted to the optical modulator 3 where signal light is intensity-modulated and optically transmitted through the optical fiber transmission line 5. In the optical receiver 8, the transmitted batched FM-modulated signals are optical/electrical-converted in the optical receive unit 6 and FM-demodulated in the FM demodulator 7, thereby regenerating the frequency-multiplexed multi-channel signals.

As described above, the delay equalizer 2 can equalize the delay deviation of the whole system, that is, on the batched FM-modulated signal transmission lines of the optical transmitter 4, the optical fiber transmission line 5 and the optical receiver 8, thus reducing the delay distortion stemming from the delay deviation to realize a high-quality transmission of the frequency-multiplexed multi-channel signals.

(Second Optical Transmitter According to the Invention)

A second optical transmitter according to the present invention has an arrangement similar to that of the above-described first optical transmitter according to the invention except that the delay equalizer according to the second embodiment (see FIG. 2) are used instead.

With this arrangement, in the optical transmitter 4, frequency-multiplexed multi-channel signals inputted are FM-modulated in batches in the FM modulator 1. Subsequently, the delay equalizer 2 gives, to the obtained batched FM-modulated signals, a delay equalization quantity needed for equalizing a delay deviation in the batched FM-modulated signal transmission line in the optical transmitter 4. Following this, the batched FM-modulated signals are inputted to the optical modulator 3 where signal light is intensity-modulated and optically transmitted through the optical fiber transmission line 5. In this case, since the delay equalizer 2 is constructed according to the second embodiment, the center frequency is made variable by being controlled from the external to vary the delay characteristic as shown in FIG. 4, thus providing an optimal delay equalization characteristic with respect to the delay deviation on the batched FM-modulated signal transmission line in the optical transmitter 4.

As described above, the delay equalizer 2 can equalize the delay deviation on the batched FM-modulated signal transmission line in the optical transmitter 4, thus reducing the delay distortion stemming from the delay deviation so that high-quality transmission of frequency-multiplexed multi-channel signals is realizable.

(Second Optical Transmission System Using Optical Transmitter According to the Invention)

In a second optical transmission system using an optical transmitter according to the present invention, the delay equalizer 2 according to the second embodiment (see FIG. 2) is used in place of the delay equalizer 2 in the above-described first optical transmission system (see FIG. 17).

With this configuration, frequency-multiplexed multi-channel signals inputted to the optical transmitter 4 are FM-modulated in batches in the FM modulator 1. The batched FM-modulated signals obtained in this way are inputted to the delay equalizer 2 which produces and adds a delay equalization quantity needed for equalizing the entire or total delay deviation on the batched FM-modulated signal transmission line existing within the optical transmitter 4, the optical fiber transmission line 5 and the batched FM-modulated signal transmission line existing within the optical receiver 8, and then outputted to the optical modulator 3 where signal light is intensity-modulated and optically transmitted through the optical fiber transmission line 5. In the optical receiver 8, the transmitted batched FM-modulated signals are optical/electrical-converted in the optical receive unit 6 and FM-demodulated in the FM demodulator 7, thereby regenerating the frequency-multiplexed multi-channel signals. In this case, since the delay equalizer is constructed according to the second embodiment, the center frequency causing a variation of the delay characteristic is controllable from the external to vary, which provides the optimal delay equalization characteristic with respect to the delay deviation on the batched FM-modulated signal transmission lines of the optical transmitter 4, the optical fiber transmission line 5 and the optical receiver 8.

As described above, the delay equalizer 2 can equalize the delay deviation of the whole system, that is, on the batched FM-modulated signal transmission lines of the optical transmitter 4, the optical fiber transmission line 5 and the optical receiver 8, thus reducing the delay distortion stemming from the delay deviation to realize a high-quality transmission of the frequency-multiplexed multi-channel signals.

(Third Optical Transmitter According to the Invention)

A third optical transmitter according to the present invention is constructed with the delay equalizer 2 in the optical transmitter shown in FIG. 16 being replaced with the delay equalizer 2 according to the third embodiment (see FIG. 5).

With this arrangement, in the optical transmitter 4, frequency-multiplexed multi-channel signals inputted are FM-modulated in batches in the FM modulator 1. Subsequently, the delay equalizer 2 gives, to the obtained batched FM-modulated signals, a delay equalization quantity needed for equalizing a delay deviation in the batched FM-modulated signal transmission line in the optical transmitter 4. Following this, the batched FM-modulated signals are inputted to the optical modulator 3 where signal light is intensity-modulated and optically transmitted through the optical fiber transmission line 5. In this case, since the delay equalizer 2 is constructed according to the third embodiment, although a simple circuit arrangement is put to use, the delay equalization quantity is made variable by being controlled from the external, thus providing an optimal delay equalization characteristic with respect to the delay deviation of the batched FM-modulated signal transmission line in the optical transmitter 4.

As described above, the delay equalizer 2 can equalize the delay deviation of the batched FM-modulated signal transmission line in the optical transmitter 4, thus reducing the delay distortion stemming from the delay deviation so that high-quality transmission of frequency-multiplexed multi-channel signals is realizable.

(Third Optical Transmission System Using Optical Transmitter According to the Invention)

In a third optical transmission system using an optical transmitter according to the present invention, the delay equalizer 2 according to the third embodiment (see FIG. 5) is used in place of the delay equalizer 2 in the above-described first optical transmission system (see FIG. 17).

With this configuration, frequency-multiplexed multi-channel signals inputted to the optical transmitter 4 are FM-modulated in batches in the FM modulator 1. The batched FM-modulated signals obtained in this way are inputted to the delay equalizer 2 which gives a delay equalization quantity needed for equalizing the entire delay deviation on the batched FM-modulated signal transmission line in the optical transmitter 4, the optical fiber transmission line 5 and the batched FM-modulated signal transmission line in the optical receiver 8, and then outputted to the optical modulator 3 where signal light is intensity-modulated and optically transmitted through the optical fiber transmission line 5. In the optical receiver 8, the transmitted batched FM-modulated signals are optical/electrical-converted in the optical receive unit 6 and FM-demodulated in the FM demodulator 7, thereby regenerating the frequency-multiplexed multi-channel signals. In this case, since the delay equalizer 2 according to the third embodiment is put to use, the delay equalization quantity is made variable by being controlled from the external with a simple circuit, thus providing an optimal delay equalization characteristic with respect to the delay deviation on the batched FM-modulated signal transmission lines of the optical transmitter 8, the optical fiber transmission line 5 and the optical receiver 8.

As described above, the delay equalizer 2 can equalize the delay deviation of the whole system, that is, on the batched FM-modulated signal transmission lines of the optical transmitter 4, the optical fiber transmission line 5 and the optical receiver 8, thus reducing the delay distortion stemming from the delay deviation to realize a high-quality transmission of the frequency-multiplexed multi-channel signals.

(Fourth Optical Transmitter According to the Invention)

A fourth optical transmitter according to the present invention is constructed with the delay equalizer 2 in the optical transmitter shown in FIG. 16 being replaced with the delay equalizer according to the fourth embodiment (see FIG. 6).

With this arrangement, in the optical transmitter 4, frequency-multiplexed multi-channel signals inputted are FM-modulated in batches in the FM modulator 1. Subsequently, the delay equalizer 2 gives, to the obtained batched FM-modulated signals, a delay equalization quantity needed for equalizing a delay deviation in the batched FM-modulated signal transmission line in the optical transmitter 4. Following this, the batched FM-modulated signals are inputted to the optical modulator 3 where signal light is intensity-modulated and optically transmitted through the optical fiber transmission line 5. In this case, since the delay equalizer 2 is constructed according to the fourth embodiment, although a simple circuit arrangement is put to use, the center frequency causing a variation of the delay characteristic is controllable through the voltage control from the external to vary, which provides the optimal delay equalization characteristic with respect to the delay deviation on the batched FM-modulated signal transmission line in the optical transmitter 4.

As described above, the delay equalizer 2 can equalize the delay deviation of the batched FM-modulated signal transmission line in the optical transmitter 4, thus reducing the delay distortion stemming from the delay deviation so that high-quality transmission of frequency-multiplexed multi-channel signals is realizable.

(Fourth Optical Transmission System Using Optical Transmitter According to the Invention)

In a fourth optical transmission system using an optical transmitter according to the present invention, the delay equalizer 2 according to the fourth embodiment (see FIG. 6) is used in place of the delay equalizer 2 in the above-described first optical transmission system (see FIG. 17).

With this configuration, frequency-multiplexed multi-channel signals inputted to the optical transmitter 4 are FM-modulated in batches in the FM modulator 1. The batched FM-modulated signals obtained in this way are inputted to the delay equalizer 2 which introduces a delay equalization quantity needed for equalizing the entire delay deviation on the batched FM-modulated signal transmission line in the optical transmitter 4, the optical fiber transmission line 5 and the batched FM-modulated signal transmission line in the optical receiver 8, and then outputted to the optical modulator 3 where signal light is intensity-modulated and optically transmitted through the optical fiber transmission line 5. In the optical receiver 8, the transmitted batched FM-modulated signals are optical/electrical-converted in the optical receive unit 6 and FM-demodulated in the FM demodulator 7, thereby regenerating the frequency-multiplexed multi-channel signals. In this case, since the delay equalizer 2 according to the fourth embodiment is put to use, the center frequency causing variation of the delay characteristic is controllable through the voltage control from the external to vary, which provides the optimal delay equalization characteristic with respect to the delay deviation on the batched FM-modulated signal transmission lines in the optical transmitter 4, the optical fiber transmission line 5 and the batched FM-modulated signal transmission line in the optical receiver 8.

As described above, the delay equalizer 2 can equalize the delay deviation of the whole system, that is, on the batched FM-modulated signal transmission lines of the optical transmitter 4, the optical fiber transmission line 5 and the optical receiver 8, thus reducing the delay distortion stemming from the delay deviation to realize a high-quality transmission of the frequency-multiplexed multi-channel signals.

(Fifth Optical Transmitter According to the Invention)

A fifth optical transmitter according to the present invention is constructed with the delay equalizer 2 in the optical transmitter shown in FIG. 16 being replaced with the delay equalizer according to the fifth embodiment (see FIG. 7).

With this arrangement, in the optical transmitter 4, frequency-multiplexed multi-channel signals inputted are FM-modulated in batches in the FM modulator 1. Subsequently, the delay equalizer 2 adds, to the obtained batched FM-modulated signals, a delay equalization quantity needed for equalizing a delay deviation in the batched FM-modulated signal transmission line in the optical transmitter 4. Following this, the batched FM-modulated signals are inputted to the optical modulator 3 where signal light is intensity-modulated and optically transmitted through the optical fiber transmission line 5. In this case, since the delay equalizer 2 is constructed according to the fifth embodiment, although a simple circuit arrangement is put to use, the center frequency causing a variation of the delay characteristic is controllable through the voltage control from the external to vary and the delay equalization quantity is controllable from the external, which provides the optimal delay equalization characteristic with respect to the delay deviation on the batched FM-modulated signal transmission line in the optical transmitter 4.

As described above, the delay equalizer 2 can equalize the delay deviation of the batched FM-modulated signal transmission line in the optical transmitter 4, thus reducing the delay distortion stemming from the delay deviation so that high-quality transmission of frequency-multiplexed multi-channel signals is realizable.

(Fifth Optical Transmission System Using Optical Transmitter According to the Invention)

In a fifth optical transmission system using an optical transmitter according to the present invention, the delay equalizer 2 according to the fifth embodiment (see FIG. 7) is used in place of the delay equalizer 2 in the above-described first optical transmission system (see FIG. 17).

With this configuration, frequency-multiplexed multi-channel signals inputted to the optical transmitter 4 are FM-modulated in batches in the FM modulator 1. The batched FM-modulated signals obtained in this way are inputted to the delay equalizer 2 which introduces a delay equalization quantity needed for equalizing the entire delay deviation on the batched FM-modulated signal transmission line in the optical transmitter 4, the optical fiber transmission line 5 and the batched FM-modulated signal transmission line in the optical receiver 8, and then outputted to the optical modulator 3 where signal light is intensity-modulated and optically transmitted through the optical fiber transmission line 5. In the optical receiver 8, the transmitted batched FM-modulated signals are optical/electrical-converted in the optical receive unit 6 and FM-demodulated in the FM demodulator 7, thereby regenerating the frequency-multiplexed multi-channel signals. In this case, since the delay equalizer 2 according to the fifth embodiment is put to use, the center frequency causing variation of the delay characteristic is controllable through the voltage control from the external to vary and the delay equalization quantity is variable, which provides the optimal delay equalization characteristic with respect to the delay deviation on the batched FM-modulated signal transmission lines in the optical transmitter 4, the optical fiber transmission line 5 and the batched FM-modulated signal transmission line in the optical receiver 8.

As described above, the delay equalizer 2 can equalize the delay deviation of the whole system, that is, on the batched FM-modulated signal transmission lines of the optical transmitter 4, the optical fiber transmission line 5 and the optical receiver 8, thus reducing the delay distortion stemming from the delay deviation to realize a high-quality transmission of the frequency-multiplexed multi-channel signals.

(Sixth Optical Transmitter According to the Invention)

A sixth optical transmitter according to the present invention is constructed with the delay equalizer 2 in the optical transmitter shown in FIG. 16 being replaced with the delay equalizer according to the sixth embodiment (see FIG. 8).

With this arrangement, in the optical transmitter 4, frequency-multiplexed multi-channel signals inputted are FM-modulated in batches in the FM modulator 1. Subsequently, the delay equalizer 2 introduces, into the obtained batched FM-modulated signals, a delay equalization quantity needed for equalizing a delay deviation in the batched FM-modulated signal transmission line in the optical transmitter 4. Following this, the batched FM-modulated signals are inputted to the optical modulator 3 where signal light is intensity-modulated and optically transmitted through the optical fiber transmission line 5. In this case, since the delay equalizer 2 is constructed with a delay equalizer, in which a plurality of delay equalizing sections #1, #2, . . . , #N cascade-connected, according to the sixth embodiment, each of the center frequencies f1, f2, f3 (fN) for delay-equalizing the delay equalizing sections #1, #2, . . . , #N is determined according to resonance frequency of each of the resonance circuits comprising an inductor and a capacitor, and the delay equalizing sections #1, #2, . . . , #N have different delay equalization center frequencies, respectively, and further the resistance value of the variable resistor of each of the delay equalizing sections #1, #2, . . . , #N is independently controlled to vary the delay equalization quantity, which permits free variation of the delay equalization characteristic over a wide band of frequencies so that it is possible to provide an optimal delay equalization characteristic with respect to the delay deviation on the batched FM-modulated signal transmission line in the optical transmitter 4 over a wide band of frequencies.

As described above, the delay equalizer 2 can equalize the delay deviation on the batched FM-modulated signal transmission line in the optical transmitter 4, thus reducing the delay distortion stemming from the delay deviation so that high-quality transmission of frequency-multiplexed multi-channel signals is realizable.

(Sixth Optical Transmission System Using Optical Transmitter According to the Invention)

In a sixth optical transmission system using an optical transmitter according to the present invention, the delay equalizer 2 according to the sixth embodiment (see FIG. 8) is used in place of the delay equalizer 2 in the above-described first optical transmission system (see FIG. 17).

With this configuration, frequency-multiplexed multi-channel signals inputted to the optical transmitter 4 are FM-modulated in batches in the FM modulator 1. The batched FM-modulated signals obtained in this way are inputted to the delay equalizer 2 which introduces a delay equalization quantity needed for equalizing the entire delay deviation on the batched FM-modulated signal transmission line in the optical transmitter 4, the optical fiber transmission line 5 and the batched FM-modulated signal transmission line in the optical receiver 8, and then outputted to the optical modulator 3 where signal light is intensity-modulated and optically transmitted through the optical fiber transmission line 5. In the optical receiver 8, the transmitted batched FM-modulated signals are optical/electrical-converted in the optical receive unit 6 and FM-demodulated in the FM demodulator 7, thereby regenerating the frequency-multiplexed multi-channel signals. In this case, since the delay equalizer 2 is constructed with a delay equalizer, in which a plurality of delay equalizing sections #1, #2, . . . , #N cascade-connected, according to the sixth embodiment, each of the center frequencies f1, f2, f3 (fN) for delay equalization in the delay equalizing sections #1, #2, . . . , #N is determined by the resonance frequency of each of the resonance circuits comprising an inductor and a capacitor, and the delay equalizing sections #1, #2, . . . , #N have different delay equalization center frequencies, respectively, and further the resistance value of the variable resistor of each of the delay equalizing sections #1, #2, . . . , #N is independently controlled to vary the delay equalization quantity, which permits arbitrary variation of the delay equalization characteristic over a wide band of frequencies so that it is possible to provide an optimal delay equalization characteristic with respect to the delay deviation on the batched FM-modulated signal transmission lines of the optical transmitter 4, the optical fiber transmission line 5 and the optical receiver 8 over a wide band of frequencies.

As described above, the delay equalizer 2 can equalize the delay deviation of the whole system, that is, on the batched FM-modulated signal transmission lines of the optical transmitter 4, the optical fiber transmission line 5 and the optical receiver 8, thus reducing the delay distortion stemming from the delay deviation to realize a high-quality transmission of the frequency-multiplexed multi-channel signals.

(Seventh Optical Transmitter According to the Invention)

A seventh optical transmitter according to the present invention is constructed with the delay equalizer 2 in the optical transmitter shown in FIG. 16 being replaced with the delay equalizer according to the seventh embodiment (see FIG. 12).

With this arrangement, in the optical transmitter 4, frequency-multiplexed multi-channel signals inputted are FM-modulated in batches in the FM modulator 1. Subsequently, the delay equalizer 2 introduces, into the obtained batched FM-modulated signals, a delay equalization quantity needed for equalizing a delay deviation in the batched FM-modulated signal transmission line in the optical transmitter 4. Following this, the batched FM-modulated signals are inputted to the optical modulator 3 where signal light is intensity-modulated and optically transmitted through the optical fiber transmission line 5. In this case, since the delay equalizer 2 is constructed with a delay equalizer according to the seventh embodiment, the capacitance of the variable capacitor is controlled to vary the resonance frequency of the resonance circuit comprising an inductor and a capacitor, thus varying each of the center frequencies f1, f2, f3 (fN) for determining the delay characteristic, and the resistance of the variable resistor of each of the delay equalizing sections #1, #2, . . . , #N is controlled to vary the delay equalization quantity, thus permitting arbitrary variation of the delay equalization characteristic over a wide band of frequencies so that it is possible to provide an optimal delay equalization characteristic with respect to the delay deviation on the batched FM-modulated signal transmission line in the optical transmitter 4 over a wide band of frequencies.

As described above, the delay equalizer 2 can equalize the delay deviation on the batched FM-modulated signal transmission line in the optical transmitter 4, thus reducing the delay distortion stemming from the delay deviation so that high-quality transmission of frequency-multiplexed multi-channel signals is realizable.

(Seventh Optical Transmission System Using Optical Transmitter According to the Invention)

In a seventh optical transmission system using an optical transmitter according to the present invention, the delay equalizer 2 according to the seventh embodiment (see FIG. 12) is used in place of the delay equalizer 2 in the above-described first optical transmission system (see FIG. 17).

With this configuration, frequency-multiplexed multi-channel signals inputted to the optical transmitter 4 are FM-modulated in batches in the FM modulator 1. The batched FM-modulated signals obtained in this way are inputted to the delay equalizer 2 which introduces a delay equalization quantity needed for equalizing the entire delay deviation on the batched FM-modulated signal transmission line in the optical transmitter 4, the optical fiber transmission line 5 and the batched FM-modulated signal transmission line in the optical receiver 8, and then outputted to the optical modulator 3 where signal light is intensity-modulated and optically transmitted through the optical fiber transmission line 5. In the optical receiver 8, the transmitted batched FM-modulated signals are optical/electrical-converted in the optical receive unit 6 and FM-demodulated in the FM demodulator 7, thereby regenerating the frequency-multiplexed multi-channel signals. In this case, since the delay equalizer 2 is constructed with a delay equalizer according to the seventh embodiment, the capacitance of the variable capacitor is controlled to vary the resonance frequency of the resonance circuit comprising an inductor and a capacitor, thus varying each of the center frequencies f1, f2, f3 (fN) for determining the delay characteristic, and the resistance of the variable resistor of each of the delay equalizing sections #1, #2, . . . , #N is controlled to vary the delay equalization quantity, thus permitting arbitrary variation of the delay equalization characteristic over a wide band of frequencies so that it is possible to provide an optimal delay equalization characteristic with respect to the delay deviation on the batched FM-modulated signal transmission lines of the optical transmitter 4, the optical fiber transmission line 5 and the optical receiver 8 over a wide band of frequencies.

As described above, the delay equalizer 2 can equalize the delay deviation of the whole system, that is, on the batched FM-modulated signal transmission lines of the optical transmitter 4, the optical fiber transmission line 5 and the optical receiver 8, thus reducing the delay distortion stemming from the delay deviation to realize a high-quality transmission of the frequency-multiplexed multi-channel signals.

(Eighth Optical Transmitter According to the Invention)

An eighth optical transmitter according to the present invention is constructed with the delay equalizer 2 in the optical transmitter shown in FIG. 16 being replaced with the delay equalizer according to the eighth embodiment (see FIG. 13).

With this arrangement, in the optical transmitter 4, frequency-multiplexed multi-channel signals inputted are FM-modulated in batches in the FM modulator 1. Subsequently, the delay equalizer 2 introduces, into the obtained batched FM-modulated signals, a delay equalization quantity needed for equalizing a delay deviation in the batched FM-modulated signal transmission line in the optical transmitter 4. Following this, the batched FM-modulated signals are inputted to the optical modulator 3 where signal light is intensity-modulated and optically transmitted through the optical fiber transmission line 5. In this case, since the delay equalizer 2 is constructed with a delay equalizer according to the eighth embodiment, a circuit for controlling the current flowing through a PIN diode is placed in each of the delay equalizing sections #1, #2, . . . , #N, and the voltage is controlled from the external to independently control the current flowing through the PIN diode in each of the delay equalizing sections #1, #2, . . . , #N for varying the internal resistance value, thus permitting arbitrary variation of the delay equalization characteristic over a wide band of frequencies so that it is possible to provide an optimal delay equalization characteristic with respect to the delay deviation on the batched FM-modulated signal transmission line in the optical transmitter 4 over a wide band of frequencies.

As described above, the delay equalizer 2 can equalize the delay deviation on the batched FM-modulated signal transmission line in the optical transmitter 4, thus reducing the delay distortion stemming from the delay deviation so that high-quality transmission of frequency-multiplexed multi-channel signals is realizable.

(Eighth Optical Transmission System Using Optical Transmitter According to the Invention)

In an eighth optical transmission system using an optical transmitter according to the present invention, the delay equalizer 2 according to the eighth embodiment (see FIG. 13) is used in place of the delay equalizer 2 in the above-described first optical transmission system (see FIG. 17).

With this configuration, frequency-multiplexed multi-channel signals inputted to the optical transmitter 4 are FM-modulated in batches in the FM modulator 1. The batched FM-modulated signals obtained in this way are inputted to the delay equalizer 2 which introduces a delay equalization quantity needed for equalizing the entire delay deviation on the batched FM-modulated signal transmission line in the optical transmitter 4, the optical fiber transmission line 5 and the batched FM-modulated signal transmission line in the optical receiver 8, and then outputted to the optical modulator 3 where signal light is intensity-modulated and optically transmitted through the optical fiber transmission line 5. In the optical receiver 8, the transmitted batched FM-modulated signals are optical/electrical-converted in the optical receive unit 6 and FM-demodulated in the FM demodulator 7, thereby regenerating the frequency-multiplexed multi-channel signals. In this case, since the delay equalizer 2 is constructed with a delay equalizer according to the eighth embodiment, a circuit for controlling the current flowing through a PIN diode is placed in each of the delay equalizing sections #1, #2, . . . , #N, and the voltage is controlled from the external to independently control the current flowing through the PIN diode in each of the delay equalizing sections #1, #2, . . . , #N for varying the internal resistance value, thus permitting arbitrary variation of the delay equalization characteristic over a wide band of frequencies so that it is possible to provide an optimal delay equalization characteristic with respect to the delay deviation on the batched FM-modulated signal transmission lines of the optical transmitter 4, the optical fiber transmission line 5 and the optical receiver 8 over a wide band of frequencies.

As described above, the delay equalizer 2 can equalize the delay deviation of the whole system, that is, on the batched FM-modulated signal transmission lines of the optical transmitter 4, the optical fiber transmission line 5 and the optical receiver 8, thus reducing the delay distortion stemming from the delay deviation to realize a high-quality transmission of the frequency-multiplexed multi-channel signals.

(Ninth Optical Transmitter According to the Invention)

A ninth optical transmitter according to the present invention is constructed with the delay equalizer 2 in the optical transmitter shown in FIG. 16 being replaced with the delay equalizer according to the ninth embodiment (see FIG. 14).

With this arrangement, in the optical transmitter 4, frequency-multiplexed multi-channel signals inputted are FM-modulated in batches in the FM modulator 1. Subsequently, the delay equalizer 2 introduces, into the obtained batched FM-modulated signals, a delay equalization quantity needed for equalizing a delay deviation in the batched FM-modulated signal transmission line in the optical transmitter 4. Following this, the batched FM-modulated signals are inputted to the optical modulator 3 where signal light is intensity-modulated and optically transmitted through the optical fiber transmission line 5. In this case, since the delay equalizer 2 is constructed with a delay equalizer according to the ninth embodiment, a circuit for controlling the voltage value across a voltage variable capacitor is placed in each of the delay equalizing sections #1, #2, . . . , #N, and the voltage value across a voltage variable capacitor in each of the delay equalizing sections #1, #2, . . . , #N is controlled independently from the external to vary the resonance frequency of the resonance circuit comprising an inductor and a capacitor, thus freely varying each of the center frequencies f1, f2, f3 (fN) for determining the delay characteristic of each of the delay equalizing sections #1, #2, . . . , #N. In addition, the resistance of the variable resistor of each of the delay equalizing sections #1, #2, . . . , #N is controlled independently from the external to vary the delay equalization quantity, thus permitting arbitrary variation of the delay equalization quantity over a wide band of frequencies so that it is possible to provide an optimal delay equalization characteristic with respect to the delay deviation on the batched FM-modulated signal transmission line in the optical transmitter 4 over a wide band of frequencies.

As described above, the delay equalizer 2 can equalize the delay deviation on the batched FM-modulated signal transmission line in the optical transmitter 4, thus reducing the delay distortion stemming from the delay deviation so that high-quality transmission of frequency-multiplexed multi-channel signals is realizable.

(Ninth Optical Transmission System Using Optical Transmitter According to the Invention)

In a ninth optical transmission system using an optical transmitter according to the present invention, the delay equalizer 2 according to the ninth embodiment (see FIG. 14) is used in place of the delay equalizer 2 in the above-described first optical transmission system (see FIG. 17).

With this configuration, frequency-multiplexed multi-channel signals inputted to the optical transmitter 4 are FM-modulated in batches in the FM modulator 1. The batched FM-modulated signals obtained in this way are inputted to the delay equalizer 2 which introduces a delay equalization quantity needed for equalizing the entire delay deviation on the batched FM-modulated signal transmission line in the optical transmitter 4, the optical fiber transmission line 5 and the batched FM-modulated signal transmission line in the optical receiver 8, and then outputted to the optical modulator 3 where signal light is intensity-modulated and optically transmitted through the optical fiber transmission line 5. In the optical receiver 8, the transmitted batched FM-modulated signals are optical/electrical-converted in the optical receive unit 6 and FM-demodulated in the FM demodulator 7, thereby regenerating the frequency-multiplexed multi-channel signals. In this case, since the delay equalizer 2 is constructed with a delay equalizer according to the ninth embodiment, a circuit for controlling the voltage value across a voltage variable capacitor is placed in each of the delay equalizing sections #1, #2, . . . , #N, and the voltage value across a voltage variable capacitor in each of the delay equalizing sections #1, #2, . . . , #N is controlled independently from the external to vary the resonance frequency of the resonance circuit comprising an inductor and a capacitor, thus freely varying each of the center frequencies f1, f2, f3 (fN) for determining the delay characteristic of each of the delay equalizing sections #1, #2, . . . , #N. In addition, the resistance of the variable resistor of each of the delay equalizing sections #1, #2, . . . , #N is controlled independently from the external to vary the delay equalization quantity, thus permitting arbitrary variation of the delay equalization characteristic over a wide band of frequencies so that it is possible to provide an optimal delay equalization characteristic with respect to the delay deviation on the batched FM-modulated signal transmission lines of the optical transmitter 4, the optical fiber transmission line 5 and the optical receiver 8 over a wide band of frequencies.

As described above, the delay equalizer 2 can equalize the delay deviation of the whole system, that is, on the batched FM-modulated signal transmission lines of the optical transmitter 4, the optical fiber transmission line 5 and the optical receiver 8, thus reducing the delay distortion stemming from the delay deviation to realize a high-quality transmission of the frequency-multiplexed multi-channel signals.

(Tenth Optical Transmitter According to the Invention)

A tenth optical transmitter according to the present invention is constructed with the delay equalizer 2 in the optical transmitter shown in FIG. 16 being replaced with the delay equalizer according to the tenth embodiment (see FIG. 15).

With this arrangement, in the optical transmitter 4, frequency-multiplexed multi-channel signals inputted are FM-modulated in batches in the FM modulator 1. Subsequently, the delay equalizer 2 introduces, into the obtained batched FM-modulated signals, a delay equalization quantity needed for equalizing a delay deviation in the batched FM-modulated signal transmission line in the optical transmitter 4. Following this, the batched FM-modulated signals are inputted to the optical modulator 3 where signal light is intensity-modulated and optically transmitted through the optical fiber transmission line 5. In this case, since the delay equalizer 2 is constructed with a delay equalizer according to the tenth embodiment, a circuit for controlling the voltage value across a voltage variable capacitor is placed in each of the delay equalizing sections #1, #2, . . . , #N, and the voltage value across a voltage variable capacitor in each of the delay equalizing sections #1, #2, . . . , #N is controlled independently from the external to vary the resonance frequency of the resonance circuit comprising an inductor and a capacitor, thus freely varying each of the center frequencies f1, f2, f3 (fN) for determining the delay characteristic of each of the delay equalizing sections #1, #2, . . . , #N. In addition, a current flowing through a PIN diode in each of the delay equalizing sections #1, #2, . . . , #N is controlled independently through a voltage variation from the external to vary its internal resistance, thus permitting arbitrary variation of the delay equalization quantity over a wide band so that it is possible to provide an optimal delay equalization characteristic with respect to the delay deviation on the batched FM-modulated signal transmission line in the optical transmitter 4 over a wide band of frequencies.

As described above, the delay equalizer 2 can equalize the delay deviation on the batched FM-modulated signal transmission line in the optical transmitter 4, thus reducing the delay distortion stemming from the delay deviation so that high-quality transmission of frequency-multiplexed multi-channel signals is realizable.

(Tenth Optical Transmission System Using Optical Transmitter According to the Invention)

In a tenth optical transmission system using an optical transmitter according to the present invention, the delay equalizer 2 according to the tenth embodiment (see FIG. 15) is used in place of the delay equalizer 2 in the above-described first optical transmission system (see FIG. 17).

With this configuration, frequency-multiplexed multi-channel signals inputted to the optical transmitter 4 are FM-modulated in batches in the FM modulator 1. The batched FM-modulated signals obtained in this way are inputted to the delay equalizer 2 which introduces a delay equalization quantity needed for equalizing the entire delay deviation on the batched FM-modulated signal transmission line in the optical transmitter 4, the optical fiber transmission line 5 and the batched FM-modulated signal transmission line in the optical receiver 8, and then outputted to the optical modulator 3 where signal light is intensity-modulated and optically transmitted through the optical fiber transmission line 5. In the optical receiver 8, the transmitted batched FM-modulated signals are optical/electrical-converted in the optical receive unit 6 and FM-demodulated in the FM demodulator 7, thereby regenerating the frequency-multiplexed multi-channel signals. In this case, since the delay equalizer 2 is constructed with a delay equalizer according to the tenth embodiment, a circuit for controlling the voltage value across a voltage variable capacitor is placed in each of the delay equalizing sections #1, #2, . . . , #N, and the voltage value across a voltage variable capacitor in each of the delay equalizing sections #1, #2, . . . , #N is controlled independently from the external to vary the resonance frequency of the resonance circuit comprising an inductor and a capacitor, thus freely varying each of the center frequencies f1, f2, f3 (fN) for determining the delay characteristic of each of the delay equalizing sections #1, #2, . . . , #N. In addition, a current flowing through a PIN diode in each of the delay equalizing sections #1, #2, . . . , #N is controlled independently through voltage control from the external to vary its internal resistance, thus permitting arbitrary variation of the delay equalization characteristic over a wide band so that it is possible to provide an optimal delay equalization characteristic with respect to the delay deviation on the batched FM-modulated signal transmission lines of the optical transmitter 4, the optical fiber transmission line 5 and the optical receiver 8 over a wide band of frequencies.

As described above, the delay equalizer 2 can equalize the delay deviation of the whole system, that is, on the batched FM-modulated signal transmission lines of the optical transmitter 4, the optical fiber transmission line 5 and the optical receiver 8, thus reducing the delay distortion stemming from the delay deviation to realize a high-quality transmission of the frequency-multiplexed multi-channel signals.

It should be understood that the present invention is not limited to the above-described embodiment, and that it is intended to cover all changes and modifications of the embodiments of the invention herein which do not constitute departures from the spirit and scope of the invention.

What is claimed is:

1. A delay equalizer connected between input and output terminals, comprising:
a resonance circuit including an inductor and a capacitor and having a resonance frequency for determining a center frequency for delay equalization; and
a variable resistor made variable in resistance,
with a Q value of said resonance circuit being varied by a change of a resistance of said variable resistor to vary a quantity of the delay equalization.

2. A delay equalizer connected between input and output terminals, comprising:
a resonance circuit including an inductor and a variable capacitance capacitor made variable in capacitance and having a resonance frequency for determining a center frequency for delay equalization; and
a variable resistor made variable in resistance,
with said center frequency for the delay equalization being made variable with a variation of the capacitance of said variable capacitance capacitor, and a Q value of said resonance circuit being varied with a variation of resistance of said variable resistor to vary a quantity of the delay equalization.

3. A delay equalizer according to claim 1, wherein a PIN diode is used as said variable resistor, and a power circuit is additionally provided to control a current flowing through said PIN diode, with the current flowing through said PIN diode being controlled to change an internal resistance of said PIN diode for controlling the quantity of the delay equalization.

4. A delay equalizer according to claim 2, wherein a voltage variable capacitor whose capacitance is made variable through voltage control is used as said variable capacitor, and a power circuit is additionally provided to control a voltage across said voltage variable-capacitance capacitor, with the voltage across said voltage variable capacitor being controlled to vary the resonance frequency of said resonance circuit for controlling the center frequency for the delay equalization.

5. A delay equalizer according to claim 2, wherein an PIN diode is used as said variable resistor, and a first power circuit is additionally provided to control a current flowing through said PIN diode, a voltage variable capacitor whose capacitance is made variable under voltage control is used as said variable capacitor, and a second power circuit is further provided to control a voltage across said voltage variable capacitor, with the current flowing said PIN diode being controlled by said first power circuit to vary an internal resistance of said PIN diode for controlling the quantity of the delay equalization, and the voltage across said voltage variable capacitor being controlled by said second power circuit to vary the resonance frequency of said resonance circuit for controlling the center frequency for the delay equalization.

6. A delay equalizer comprising a plurality of delay equalizing sections each including an inductor, a capacitor and a variable resistor, cascade-connected between input and output terminals, with a resistance of said variable resistor of each of said delay equalizing sections being individually controlled to vary a quantity of delay equalization according to center frequency of each delay equalizing section.

7. A delay equalizer comprising a plurality of delay equalizing sections each including an inductor, a variable capacitor and a variable resistor, cascade-connected between input and output terminals, with a capacitance of said variable capacitor of each of said delay equalizing sections being individually controlled to vary a resonance frequency of a resonance circuit comprising said inductor and said variable capacitor for controlling a center frequency for delay equalization in each of said delay equalizing sections, and a resistance of said variable resistor of each of said delay equalizing sections being individually controlled to vary a quantity of the delay equalization according to center frequency of each delay equalizing section.

8. A delay equalizer according to claim 6, wherein, in each of said delay equalizing sections, a PIN diode is used as said variable resistor, and a power circuit is additionally provided to control a current flowing through said PIN diode, with the current flowing through said PIN diode of each of said delay equalizing sections being controlled to change an internal resistance of said PIN diode for controlling a quantity of delay equalization.

9. A delay equalizer according to claim 7, wherein, in each of said delay equalizing sections, a voltage variable capacitor whose capacitance is made variable in accordance through voltage control is used as said variable capacitor, and a power circuit is additionally provided for controlling a voltage across said voltage variable capacitor, with the voltage across said voltage variable capacitor of each of said delay equalizing sections being controlled to vary the resonance frequency of said resonance circuit so that the center frequency is varied according to delay equalizing section.

10. A delay equalizer according to claim 7, wherein, in each of said delay equalizing sections, a PIN diode is used as said variable resistor, and a first power circuit is additionally provided for controlling a current passing through said PIN diode, while a voltage variable capacitor whose capacitance is made variable through voltage control is used as said variable capacitor, and a second power circuit is further provided for controlling a voltage across said voltage variable capacitor, with the current flowing through said PIN diode of each of said delay equalizing sections being controlled by said first power circuit to vary an internal resistance of said PIN diode for controlling the quantity of the delay equalization according to delay equalizing section, and the voltage across said voltage variable capacitor of each of said delay equalizing sections being controlled by said second power circuit to vary the resonance frequency of said resonance circuit for controlling the center frequency according to delay equalizing section.

11. An optical transmitter comprising:
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before said optical modulating means and including an inductor and a capacitor, which constitute a resonance circuit with a resonance frequency for determining a center frequency for delay equalization, and a variable resistor made variable in resistance, with a Q value of said resonance circuit being varied by varying a resistance of said variable resistor for controlling a quantity of delay equalization so that a delay deviation on a frequency-modulated signal transmission line being equalized by said delay equalizer to reduce a delay distortion stemming from the delay deviation.

12. An optical transmitter comprising:
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before said optical modulating means and including an inductor and a variable capacitor made variable in capacitance, which constitute a resonance circuit with a given resonance frequency which determines a center frequency for delay equalization, and a variable resistor made variable in resistance, with the center frequency for the delay equalization being varied by varying a capacitance of said variable capacitor and a Q value of said resonance circuit being varied by varying a resistance of said variable resistor for controlling a quantity of the delay equalization so that a delay deviation on a frequency-modulated signal transmission line is equalized by said delay equalizer to reduce a delay distortion stemming from the delay deviation.

13. An optical transmitter comprising:
frequency modulating means for frequency-modulating frequency-multiplexed multi-channel signals; optical modulating means for intensity-modulating signal light on the basis of the modulated signals obtained by said frequency modulating means for optical transmission; and
a delay equalizer provided before said optical modulating means and including an inductor and a capacitor, which constitute a resonance circuit with a resonance frequency determining a center frequency for delay equalization, a PIN diode made variable in resistance, and a power circuit for controlling a current flowing through said PIN diode, with a current flowing through said PIN diode being controlled to vary an internal resistance of said PIN diode for controlling a quantity of the delay equalization so that a delay deviation on a frequency-modulated signal transmission line is equalized by said delay equalizer to reduce a delay distortion stemming from the delay deviation.

14. An optical transmitter comprising:
frequency modulating means for frequency-modulating frequency-multiplexed multi-channel signals;
optical modulating means for intensity-modulating signal light with the modulated signals obtained by said frequency modulating means for optical transmission; and
a delay equalizer provided before said optical modulating means and including an inductor and a voltage variable capacitor made variable in capacitance through voltage control, which constitute a resonance circuit with a resonance frequency determining a center frequency for delay equalization, a variable resistor made variable in resistance, and a power circuit for controlling a voltage across said voltage variable capacitor, with a Q value of said resonance circuit being varied by varying a resistance of said variable resistor for controlling a quantity of the delay equalization, and the voltage across said voltage variable capacitor being controlled to vary said resonance frequency of said resonance circuit for controlling the center frequency for the delay equalization so that a delay deviation on a frequency-modulated signal transmission line is equalized by said delay equalizer to reduce a delay distortion stemming from the delay deviation.

15. An optical transmitter comprising:
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before said optical modulating means and including an inductor and a voltage variable capacitor made variable in capacitance through voltage control, which constitute a resonance circuit with a resonance frequency determining a center frequency for delay equalization, a PIN diode made variable in resistance, a first power circuit for controlling a current flowing through said PIN diode, and a second power circuit for controlling a voltage across said voltage variable capacitor, with the current flowing through said PIN diode being controlled by said first power circuit to vary an internal resistance of said PIN diode for controlling a quantity of the delay equalization, and the voltage across said voltage variable capacitor being controlled by said second power circuit to vary the resonance frequency of said resonance circuit for controlling the central frequency for the delay equalization so that a delay deviation on a frequency-modulated signal transmission line is equalized by said delay equalizer to reduce a delay distortion stemming from the delay deviation.

16. An optical transmitter comprising:
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before said optical modulating means and including a plurality of delay equalizing sections, each including an inductor, a capacitor and a variable resistor, cascade-connected between input and output terminals, with a quantity of delay equalization being varied according to center frequency of each delay equalizing section by individually controlling a resistance of said variable resistor of each of the delay equalizing sections so that a delay deviation on a frequency-modulated signal transmission line is equalized by said delay equalizer to reduce a delay distortion stemming from the delay deviation.

17. An optical transmitter comprising:
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before said optical modulating means and including a plurality of delay equalizing sections, each including an inductor, a variable capacitor and a variable resistor, cascade-connected between input and output terminals, with a resonance frequency of a resonance circuit being varied by individually controlling a capacitance of said variable capacitor of each of said delay equalizing sections for controlling a center frequency for delay equalization, and a quantity of delay equalization being varied according to center frequency by individually controlling a resistance of said variable resistor of each of said delay equalizing sections so that a delay deviation on a frequency-modulated signal transmission line is equalized by said delay equalizer to reduce a delay distortion stemming from the delay deviation.

18. An optical transmitter according to claim 16, wherein, in each of the delay equalizing sections, a PIN diode is used as said variable resistor, and a power circuit is additionally provided for controlling a current flowing through said PIN diode, with the current flowing through said PIN diode of each of said delay equalizing sections being controlled to vary an internal resistance of said PIN diode for controlling a quantity of the delay equalization.

19. An optical transmitter according to claim 17, wherein, in each of the delay equalizing sections, a voltage variable capacitor made variable in capacitance through voltage control is used as said variable capacitor, and a power circuit is additionally for controlling a voltage across said voltage variable capacitor, with the voltage value across said voltage variable capacitor of each of said delay equalizing sections being controlled to vary the resonance frequency of said resonance circuit for controlling a center frequency for each of said delay equalizing sections.

20. An optical transmitter according to claim 17, wherein, in each of the delay equalizing sections, a PIN diode is used as the variable resistor, and a first power circuit is additionally provided for controlling a current flowing through said PIN diode, while a voltage variable capacitor made variable in capacitance through voltage control is used as said variable capacitor, and a second power circuit is further provided for controlling a voltage across said voltage variable capacitor, with the current flowing through said PIN diode of each of said delay equalizing sections being controlled by said first power circuit to vary an internal resistance of said PIN diode for controlling a quantity of the delay equalization according to delay equalizing section, and the voltage across said voltage variable capacitor each of said delay equalizing sections being controlled by said second power circuit to vary the resonance frequency of said resonance circuit for controlling the center frequency according to delay equalizing section.

21. An optical transmission system comprising:
an optical transmitter including:
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before the optical modulating means and is composed of a resonance circuit comprising an inductor and a capacitor and having a resonance frequency for determining a center frequency for delay equalization, and a variable resistor made variable in resistance, with a Q value of said resonance circuit being varied in accordance with a variation of a resistance of said variable resistor for controlling a quantity of the delay equalization; and
an optical receiver for optical/electrical-converting and frequency-demodulating an optical signal transmitted from said optical transmitter to transmit frequency-multiplexed multi-channel signals,
said delay equalizer equalizing a delay deviation on a frequency-modulated signal transmission line in said optical transmitter and further equalizing a delay deviation on a frequency-modulated signal transmission line in said optical receiver to reduce a delay distortion stemming from the delay deviations from said optical transmitter to said optical receiver.

22. An optical transmission system comprising:
an optical transmitter including;
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before said optical modulating means and composed of a resonance circuit comprising an inductor and a variable capacitor made variable in capacitance and having a resonance frequency determining a center frequency for delay equalization, and a variable resistor made variable in resistance, with the center frequency for the delay equalization being varied in accordance with a variation of a capacitance of said variable capacitor, and a Q value of said resonance circuit being varied in accordance with a variation of a resistance of said variable resistor for controlling a quantity of the delay equalization; and
an optical receiver for optical/electrical-converting and frequency-demodulating an optical signal transmitted from said optical transmitter to transmit frequency-multiplexed multi-channel signals,
said delay equalizer equalizing a delay deviation on a frequency-modulated signal transmission line in said optical transmitter and further equalizing a delay deviation on a frequency-modulated signal transmission line in said optical receiver to reduce a delay distortion stemming from the delay deviations from said optical transmitter to said optical receiver.

23. An optical transmission system comprising:
an optical transmitter including;
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before said optical modulating means and composed of a resonance circuit comprising an inductor and a capacitor and having a resonance frequency for determining a center frequency for delay equalization, a PIN diode made variable in resistance, and a power circuit for controlling a current passing through said PIN diode, with a current flowing through said PIN diode being controlled to vary an internal resistance of said PIN diode for controlling a quantity of delay equalization; and
an optical receiver for optical/electrical-converting and frequency-demodulating an optical signal transmitted from said optical transmitter to transmit frequency-multiplexed multi-channel signals,
said delay equalizer equalizing a delay deviation on a frequency-modulated signal transmission line in said optical transmitter and further equalizing a delay deviation on a frequency-modulated signal transmission line in said optical receiver to reduce a delay distortion stemming from the delay deviations from said optical transmitter to said optical receiver.

24. An optical transmission system comprising:
an optical transmitter including;
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before said optical modulating means and composed of a resonance circuit comprising an inductor and a voltage variable capacitor made variable in capacitance through voltage control and having a resonance frequency for determining a center frequency for delay equalization, a variable resistor made variable in resistance, and a power circuit for controlling a voltage across said voltage variable capacitor, with a Q value of said resonance circuit being varied in accordance with a variation of the resistance of said variable resistor for controlling a quantity of the delay equalization, and the voltage across said voltage variable capacitor being controlled to vary the resonance frequency of said resonance circuit for controlling the center frequency for the delay equalization; and
an optical receiver for optical/electrical-converting and frequency-demodulating an optical signal transmitted from said optical transmitter to transmit frequency-multiplexed multi-channel signals,
said delay equalizer equalizing a delay deviation on a frequency-modulated signal transmission line in said optical transmitter and further equalizing a delay deviation on a frequency-modulated signal transmission line in said optical receiver to reduce a delay distortion stemming from the delay deviations from said optical transmitter to said optical receiver.

25. An optical transmission system comprising:
an optical transmitter including;
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before said optical modulating means and composed of a resonance circuit comprising an inductor and a voltage variable capacitor made variable in capacitance through voltage control and having a resonance frequency for determining a center frequency for delay equalization, a PIN diode made variable in resistance, a first power circuit for controlling a current flowing through said PIN diode, and a second power circuit for controlling a voltage across said voltage variable capacitor, with the current flowing through said PIN diode being controlled by said first power circuit to vary an internal resistance of said PIN diode for controlling a quantity of the delay equalization, and the voltage across said voltage variable capacitor being controlled by said second power circuit to vary the resonance frequency of said resonance circuit for controlling the center frequency for the delay equalization; and
an optical receiver for optical/electrical-converting and frequency-demodulating an optical signal transmitted from said optical transmitter to transmit frequency-multiplexed multi-channel signals,
said delay equalizer equalizing a delay deviation on a frequency-modulated signal transmission line in said optical transmitter and further equalizing a delay deviation on a frequency-modulated signal transmission line in said optical receiver to reduce a delay distortion stemming from the delay deviations from said optical transmitter to said optical receiver.

26. An optical transmission system comprising:
an optical transmitter including;
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before said optical modulating means and composed of a plurality of delay equalizing sections, each including an inductor, a capacitor and a variable resistor, cascade-connected between input and output terminals, with a resistance of said variable resistor of each of said delay equalizing sections being controlled individually for controlling a quantity of delay equalization according to center frequency of each of said delay equalizing sections; and
an optical receiver for optical/electrical-converting and frequency-demodulating an optical signal transmitted from said optical transmitter to transmit frequency-multiplexed multi-channel signals,
said delay equalizer equalizing a delay deviation on a frequency-modulated signal transmission line in said optical transmitter and further equalizing a delay deviation on a frequency-modulated signal transmission line in said optical receiver to reduce a delay distortion stemming from the delay deviations from said optical transmitter to said optical receiver.

27. An optical transmission system comprising:
an optical transmitter including;
frequency modulating means for frequency-modulating frequency-multiplexed multi-channel signals;
optical modulating means for intensity-modulating signal light on the basis of the modulated signals obtained by said frequency modulating means for optical transmission; and
a delay equalizer provided before said optical modulating means and composed of a plurality of delay equalizing sections, each including an inductor, a variable capacitor and a variable resistor, cascade-connected between input and output terminals, with a capacitance of said variable capacitor of each of said delay equalizing sections being control individually to vary a resonance frequency of a resonance circuit comprising said inductor and said variable capacitor for controlling a center frequency for delay equalization, and a resistance of said variable resistor of each of said delay equalizing sections being controlled individually for controlling a quantity of the delay equalization according to center frequency of each of said delay equalizing sections; and
an optical receiver for optical/electrical-converting and frequency-demodulating an optical signal transmitted from said optical transmitter to transmit frequency-multiplexed multi-channel signals,
said delay equalizer equalizing a delay deviation on a frequency-modulated signal transmission line in said optical transmitter and further equalizing a delay deviation on a frequency-modulated signal transmission line in said optical receiver to reduce a delay distortion stemming from the delay deviations from said optical transmitter to said optical receiver.

28. An optical transmission system according to claim 26, wherein, in each of said delay equalizing sections, a PIN diode is used as said variable resistor, and a power circuit is additionally provided for controlling a current value flowing through said PIN diode, with the current flowing through said PIN diode of each of said delay equalizing sections being controlled to vary an internal resistance of said PIN diode for controlling the quantity of the delay equalization.

29. An optical transmission system according to claim 27, wherein, in each of said delay equalizing sections, a voltage variable capacitor made variable in capacitance through voltage control is used as said variable capacitor, and a power circuit is additionally provided for controlling a voltage across said voltage variable capacitor, with the voltage value across said voltage variable capacitor of each of said delay equalizing sections being controlled to vary the resonance frequency of said resonance circuit for controlling the center frequency at every delay equalizing section.

30. An optical transmission system according to claim 27, wherein, in each of said delay equalizing sections, a PIN diode is used as said variable resistor, and a first power circuit is additionally provided for controlling a current flowing through said PIN diode, while a voltage variable capacitor made variable in capacitance through voltage control is used as said variable capacitor, and a second power circuit is further provided for controlling a voltage across said voltage variable capacitor, with the current flowing said PIN diode of each of said delay equalizing sections being controlled by said first power circuit to vary an internal resistance of said PIN diode for controlling the quantity of the delay equalization at every delay equalizing section, and a voltage across said voltage variable capacitor of each of said delay equalizing sections being controlled by said second power circuit to vary the resonance frequency of said resonance circuit for controlling the center frequency at every delay equalizing section.
